(19) United States
(12) Patent Application Publication
(10) Pub. No.: US 2026/0155933 A1
(43) Pub. Date: Jun. 4, 2026

(54) WIRELESS COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Wenhong CHEN, Dongguan (CN); Zhihua SHI, Dongguan (CN)

(73) Assignee: GUANGDONG OPPO MOBILE TELECOMMUNICATIONS CORP., LTD., Dongguan (CN)

(21) Appl. No.: 19/454,620

(22) Filed: Jan. 21, 2026

Related U.S. Application Data
(63) Continuation of application No. PCT/CN2023/135945, filed on Dec. 1, 2023.

(51) Int. Cl. H04L 5/00; H04B 7/06; H04L 27/26

(52) U.S. Cl. CPC H04L 5/0051; H04B 7/0639; H04L 5/0012; H04L 27/2605

(57) ABSTRACT

Provided are a wireless communication method, a terminal device, and a network device. The method includes: a terminal device receives configuration information from a network device, the configuration information being used for configuring a first SRS resource group and a second SRS resource group, the first SRS resource group including one or more 2-port SRS resources, and the second SRS resource group including one or more single-port SRS resources; the terminal device sends SRSs on the first SRS resource group and the second SRS resource group, and the terminal device receives indication information sent by the network device, the indication information including TPMI information, the TPMI information being used for determining a precoding mode on antenna ports corresponding to a first SRS resource and a second SRS resource, the first SRS resource group including the first SRS resource, and the second SRS resource group including the second SRS resource.

### CROSS-REFERENCE TO RELATED APPLICATION

This is a continuation of International Patent Application No. PCT/CN2023/135945, filed on Dec. 1, 2023, the disclosure of which is hereby incorporated by reference in its entirety.

### BACKGROUND

The related art supports codebook-based precoding processing for two antenna ports and four antenna ports. However, some terminal devices have three transmission antennas. Because the related art cannot support the codebook-based precoding processing for three antenna ports, these terminal devices have to degrade to two antenna ports for transmission, that is, a 2-port codebook is used for uplink transmission. The gain of the three transmission antennas cannot be fully utilized, resulting in a spectral efficiency being affected. If the uplink transmission for the three antenna ports is to be supported, corresponding sounding reference signal (SRS) resources supporting the three antenna ports are required for uplink channel sounding.

### SUMMARY

The disclosure relates to the technical field of communications, and more particularly, to a wireless communication method, a terminal device, and a network device. Various aspects of the disclosure are described below.

According to a first aspect, an embodiment of the disclosure provides a wireless communication method, including the following operations. A terminal device receives configuration information from a network device, and the configuration information is used for configuring a first SRS resource group and a second SRS resource group. The first SRS resource group includes one or more SRS resources for two antenna ports, and the second SRS resource group includes one or more SRS resources for a single antenna port. The terminal device transmits SRSs on the first SRS resource group and the second SRS resource group. The terminal device receives indication information from the network device, the indication information includes transmit precoding matrix indicator (TPMI) information, and the TPMI information is used for determining a precoding scheme on antenna ports corresponding to a first SRS resource and a second SRS resource. The first SRS resource group includes the first SRS resource, and the second SRS resource group includes the second SRS resource.

According to a second aspect, an embodiment of the disclosure provides a terminal device, including a processor, and a memory for storing a program executable by the processor. The processor is configured to execute the program to control the terminal device to: receive configuration information from a network device, and the configuration information is used for configuring a first SRS resource group and a second SRS resource group. The first SRS resource group includes one or more SRS resources for two antenna ports, and the second SRS resource group includes one or more SRS resources for a single antenna port. The processor is further configured to execute the program to control the terminal device to: transmit SRSs on the first SRS resource group and the second SRS resource group; and receive indication information from the network device. The indication information includes TPMI information, and the TPMI information is used for determining a precoding scheme on antenna ports corresponding to a first SRS resource and a second SRS resource. The first SRS resource group includes the first SRS resource, and the second SRS resource group includes the second SRS resource.

According to a third aspect, an embodiment of the disclosure provides a network device, including a processor, and a memory for storing a program executable by the processor. The processor is configured to execute the program to control the network device to: transmit configuration information to a terminal device, and the configuration information is used for configuring a first SRS resource group and a second SRS resource group. The first SRS resource group includes one or more SRS resources for two antenna ports, and the second SRS resource group includes one or more SRS resources for a single antenna port. The processor is further configured to execute the program to control the network device to: receive SRSs transmitted by the terminal device on the first SRS resource group and the second SRS resource group; and transmit indication information to the terminal device. The indication information includes TPMI information used for determining a precoding scheme on antenna ports corresponding to a first SRS resource and a second SRS resource. The first SRS resource group includes the first SRS resource, and the second SRS resource group includes the second SRS resource.

### BRIEF DESCRIPTION OF THE DRAWINGS

FIG. 1 is a schematic diagram of a wireless communication system to which embodiments of the disclosure are applied.

FIG. 2 is an exemplary diagram of an uplink precoding procedure in a codebook-based precoding scheme.

FIG. 3 is a schematic flowchart of a wireless communication method according to an embodiment of the disclosure.

FIG. 4 is a schematic structural diagram of a terminal device according to an embodiment of the disclosure.

FIG. 5 is a schematic structural diagram of a network device according to an embodiment of the disclosure.

FIG. 6 is a schematic structural diagram of an apparatus for communication according to an embodiment of the disclosure.

### DETAILED DESCRIPTION

Hereinafter, technical solutions in the disclosure will be described with reference to the accompanying drawings.

### Communication System

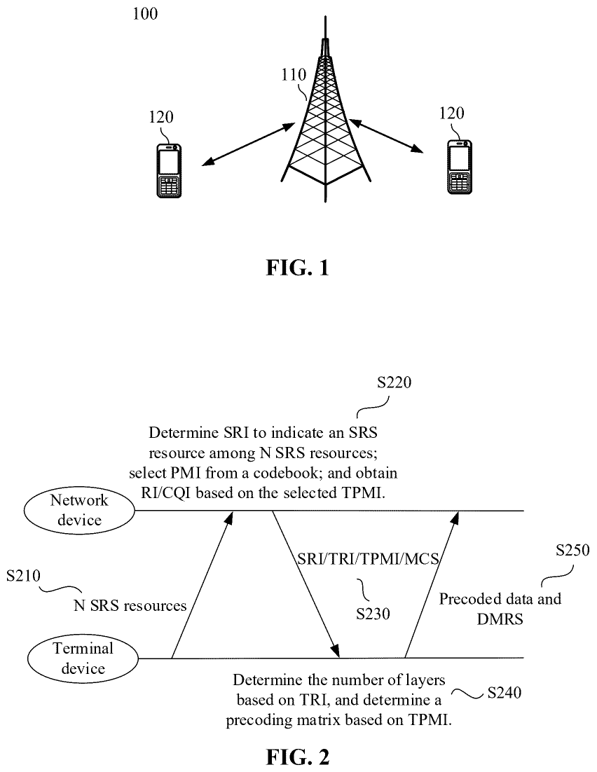

FIG. 1 illustrates a wireless communication system 100 to which embodiments of the disclosure are applied. The wireless communication system 100 may include a communication device. The communication device may include a network device 110 and a terminal device 120. The network device 110 may be a device that communicates with the terminal device 120.

FIG. 1 Illustratively illustrates one network device and two terminals. Optionally, the wireless communication system 100 may include a plurality of network devices and another number of terminal devices may be included within the coverage range of each network device, and the embodiments of the disclosure are not limited thereto.

Optionally, the wireless communication system 100 may further include other network entities such as a network controller and a mobility management entity, and the embodiments of the disclosure are not limited thereto.

It should be understood that the technical solutions in the embodiments of the disclosure may be applied to various communication systems, such as a fifth generation (5G) system or a new radio (NR) system, a long term evolution (LTE) system, an LTE frequency division duplex (FDD) system, an LTE time division duplex (TDD) system, and the like. The technical solution provided in the disclosure may also be applied to future communication systems, such as a sixth generation mobile communication system, a satellite communication system, and the like.

The terminal device in the embodiments of the disclosure may also be referred to as a user equipment (UE), an access terminal, a subscriber unit, a subscriber station, a mobile unit, a mobile station (MS), a mobile terminal (MT), a remote station, a remote terminal, a mobile device, a user terminal, a terminal, a wireless communication device, a user agent, or a user device. The terminal device in the embodiments of the disclosure may be a device that provides voice and/or data connectivity to a user, and may be used to connect people, objects, and machines, for example, a handheld device having a wireless connection function, a vehicle-mounted device, or the like. The terminal device in the embodiments of the disclosure may be a mobile phone, a Pad, a notebook computer, a handheld computer, a mobile internet device (MID), a wearable device, a virtual reality (VR) device, an augmented reality (AR) device, a wireless terminal in industrial control, a wireless terminal in self driving, a wireless terminal in remote medical surgery, a wireless terminal in smart grid, a wireless terminal in transportation safety, a wireless terminal in smart city, a wireless terminal in smart home, or the like. Optionally, the UE may function as a base station. For example, the UE may function as a scheduling entity that provides sidelink signals between UEs in vehicle-to-everything (V2X) or device-to-device (D2D), etc. For example, a cellular phone and automobile communicate with each other using the sidelink signal. The cellular phone may communicate with a smart home device without relaying a communication signal through a base station.

The network device in the embodiments of the disclosure may be a device configured to communicate with the terminal device. The network device may further include an access network device, which may provide communication coverage for a particular geographic area and may communicate with the terminal device 120 located within the coverage. The access network device may also be referred to as a radio access network device, a base station, or the like. The access network device in the embodiments of the disclosure may refer to a radio access network (RAN) node (or device) that connects the terminal device to the wireless network. The access network device may broadly cover, or be substituted for, various names among, a Node B (NodeB), an evolved NodeB (eNB), a next generation NodeB (gNB), a relay station, an access point, a transmitting and receiving point (TRP), a transmitting point (TP), a master eNB (MeNB), a secondary eNB (SeNB), a multi-standard radio (MSR) node, a home base station, a network controller, an access node, a wireless node, an access point (AP), a transmission node, a transceiver node, a base band unit (BBU), a remote radio unit (RRU), an active antenna unit (AAU), a remote radio head (RRH), a central unit (CU), a distributed unit (DU), a positioning node and the like. The base station may be a macro base station, a micro base station, a relay node, a donor node, or the like, or a combination thereof. The base station may also refer to a communication module, a modem, or a chip for installation within the aforementioned device or apparatus. The base station may be a mobile switching center, a device that performs the function of a base station in a D2D, V2X, or machine-to-machine (M2M) communication, a network-side device in a 6G network, a device that performs the function of a base station in a future communication system, or the like. The base station may support networks employing the same or different access technologies. The specific technology and the specific device form adopted by the access network device are not limited in the embodiments of the disclosure.

The base station may be fixed or mobile. For example, a helicopter or drone may be configured to act as a mobile base station, and one or more cells may move according to a location of the mobile base station. In other examples, the helicopter or drone may be configured as a device to communicate with another base station.

The communication devices involved in the wireless communication system may include not only the access network device and the terminal device, but also a core network element. The core network element may be implemented by a device, that is, the core network element is a core network device. It is to be understood that the core network device may also be a network device.

The core network element in the embodiments of the disclosure may include a network element that processes and forwards signaling and data of the user. For example, the core network device may include a core network access and mobility management function (AMF), a session management function (SMF), a user plane gateway, a location management function (LMF) and the like. The user plane gateway may be a server having functions such as mobility management, routing, and forwarding of user plane data, and is generally located on the network side, such as a serving gateway (SGW), a packet data network gateway (PGW), a user plane function (UPF), or the like. Other network elements may also be included in the core network, which will not be listed here.

In some deployments, the network device in the embodiments of the disclosure may refer to a CU or a DU, or the network device includes a CU and a DU. The gNB may also include an AAU.

The network device and the terminal device may be deployed on land, including indoor or outdoor, handheld or vehicle-mounted. The network device and the terminal device may also be deployed on the water. The network device and the terminal device may also be deployed in an aircraft, a balloon and a satellite in the air. The scenario in which the network device and the terminal device are located is not limited in the embodiments of the disclosure.

It should be understood that all or part of the functionality of the communication device in the disclosure may also be implemented by software functionality running on hardware, or by virtualization functionality instantiated on a platform, such as a cloud platform.

### Precoding Processing

In the process of interaction between the terminal device and the network device, the data may undergo precoding processing. The precoding processing enables the data to obtain precoding gain. The precoding processing may be divided into two parts: analog domain processing and digital domain processing. The analog domain processing is for a transmitted analog signal, and may map a radio frequency signal onto a physical antenna. For example, the analog domain processing may be implemented by means of beamforming. The digital domain processing is for a digital signal, and data of a transmission layer may be mapped onto a radio frequency port. The digital domain processing may be performed in baseband, for example, using a precoding matrix for precoding the digital signal.

For the terminal device, when the terminal device transmits uplink data to the network device, the terminal device may perform precoding processing on the uplink data. The precoding process may enable the uplink data to obtain an uplink precoding gain. For example, for a physical uplink share channel (PUSCH), the terminal device may perform precoding on the PUSCH.

Since the number of radio frequency channels in the terminal device is limited, the terminal device may adopt both of the above two processing methods when precoding the uplink data. That is to say, the terminal device may perform precoding on the digital signal and apply beamforming to the analog signal.

The uplink data transmission may be divided into codebook-based transmission and non-codebook-based transmission. For the codebook-based transmission, one codeword in the codebook may correspond to one precoding matrix. The codebook-based transmission and the non-codebook-based transmission adopt different precoding schemes.

The process of the uplink precoding will be described below by taking the uplink codebook-based precoding scheme shown in FIG. 2 as an example.

The network device may configure, for the terminal device, a set of SRS resources dedicated to codebook transmission. FIG. 2 illustrates that N SRS resources are included in the SRS resource set as an example, and N may be an integer greater than or equal to 1.

At S210, the terminal device transmits SRSs on the N SRS resources. The SRSs on respective SRS resources may be transmitted using different beams.

At S220, the network device selects an SRS resource from the N SRS resources (for example, it may be the SRS resource with the best signal quality). The SRS resource selected by the network device may be indicated by a sounding reference signal resource indicator (SRI). The SRS resource indicated by the SRI may also be used to obtain uplink channel state information (CSI). The network device may further determine at least one of: a transmit precoding matrix indicator (TPMI), a rank indicator (RI), or a channel quality indicator (CQI). The PMI may be selected from a codebook, and the RI or CQI may be acquired based on the selected PMI.

At S230, the network device transmits one or more of: the SRI, a transmit rank indicator (TRI), the TPMI, or a modulation and coding scheme (MCS), to the terminal device through downlink control information (DCI).

At S240, the terminal device may determine the number of layers based on the TRI, and determine an uplink precoding matrix (or a precoder) corresponding to the TPMI from the codebook based on the TRI and the TPMI.

The terminal device may perform analog beamforming on data using a beam corresponding to the SRS resource indicated by the SRI.

At S250, the terminal device transmits the pre-coded uplink data and a demodulation reference signal (DMRS) to the network device.

### Uplink Codebook

The related art supports the transmission of PUSCH over 2-port and 4-port. The codebooks (represented by W) used by different transmission layers (different multiple access modes are distinguished in a single-layer scenario) under different numbers of antenna ports may be shown in Tables 1-7. If the terminal device only supports a non-coherent codebook, each data stream may only be transmitted on a single antenna port and the single antenna port may only transmit a single data stream (transmission layer). If the terminal device supports a partially coherent codebook, each data stream may be transmitted on coherent antenna ports. That is, the data stream cannot be transmitted simultaneously on non-coherent antenna ports.

TABLE 1
Codebook used for 2-antenna port, and 1-layer transmission

| | W | | | | | | | |
|---|---|---|---|---|---|---|---|---|
| TPMI index | (ordered from left to right in increasing order of TPMI index) | | | | | | | |
| 0-5 | $\frac{1}{\sqrt{2}} [ \begin{matrix}1 \\ 0\end{matrix} ]$ | $\frac{1}{\sqrt{2}} [ \begin{matrix}0 \\ 1\end{matrix} ]$ | $\frac{1}{\sqrt{2}} [ \begin{matrix}1 \\ 1\end{matrix} ]$ | $\frac{1}{\sqrt{2}} [ \begin{matrix}1 \\ - 1\end{matrix} ]$ | $\frac{1}{\sqrt{2}} [ \begin{matrix}1 \\ j\end{matrix} ]$ | $\frac{1}{\sqrt{2}} [ \begin{matrix}1 \\ - j\end{matrix} ]$ | — | — |

TABLE 2
Codebook used for 4-antenna port, 1-layer transmission, and discrete
fourier transformation-spread-orthogonal frequency division multiplexing (DFT-S-OFDM)

| | W | | | | | | | |
|---|---|---|---|---|---|---|---|---|
| TPMI index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ - 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ - 1\end{matrix} ]$ | $\frac{1}{2} [ \begin{matrix}1 \\ - 1 \\ 1 \\ 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ - 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ - 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ 1\end{matrix} ]$ | — | — | — | — |

TABLE 3
Codebook used for 4-antenna port, 1-layer transmission, and cyclic
prefix-orthogonal frequency division multiplexing (CP-OFDM)

| | W | | | | | | | |
|---|---|---|---|---|---|---|---|---|
| TPMI index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ 1\end{matrix} ]$ | $\frac{1}{2} [ \begin{matrix}1 \\ - 1 \\ 1 \\ - 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ - 1\end{matrix} ]$ | — | — | — | — |

TABLE 4
Codebook used for 2-antenna port, 2-layer transmission, and DFT-S-
OFDM

| TPMI | W | | |
|---|---|---|---|
| index | (ordered from left to right in increasing order of TPMI index) | | |
| 0-2 | $\frac{1}{\sqrt{2}} [ \begin{matrix}1 & 0 \\ 0 & 1\end{matrix} ]$ | $\frac{1}{2} [ \begin{matrix}1 & 1 \\ 1 & - 1\end{matrix} ]$ | $\frac{1}{2} [ \begin{matrix}1 & 1 \\ j & - j\end{matrix} ]$ |

TABLE 5
Codebook used for 4-antenna port, 2-layer transmission, and CP-OFDM

| TPMI | W | | | |
|---|---|---|---|---|
| index | (ordered from left to right in increasing order of TPMI index) | | | |
| 0-3 | $\frac{1}{2} [ \begin{matrix}1 & 0 \\ 0 & 1 \\ 0 & 0 \\ 0 & 0\end{matrix} ]$ | $\frac{1}{2} [ \begin{matrix}1 & 0 \\ 0 & 0 \\ 0 & 1 \\ 0 & 0\end{matrix} ]$ | $\frac{1}{2} [ \begin{matrix}1 & 0 \\ 0 & 0 \\ 0 & 0 \\ 0 & 1\end{matrix} ]$ | $\frac{1}{2} [ \begin{matrix}0 & 0 \\ 1 & 0 \\ 0 & 1 \\ 0 & 0\end{matrix} ]$ |
| 4-7 | $\frac{1}{2} [ \begin{matrix}0 & 0 \\ 1 & 0 \\ 0 & 0 \\ 0 & 1\end{matrix} ]$ | $\frac{1}{2} [ \begin{matrix}0 & 0 \\ 0 & 0 \\ 1 & 0 \\ 0 & 1\end{matrix} ]$ | $\frac{1}{2} [ \begin{matrix}1 & 0 \\ 0 & 1 \\ 1 & 0 \\ 0 & - j\end{matrix} ]$ | $\frac{1}{2} [ \begin{matrix}1 & 0 \\ 0 & 1 \\ 1 & 0 \\ 0 & j\end{matrix} ]$ |
| 8-11 | $\frac{1}{2} [ \begin{matrix}1 & 0 \\ 0 & 1 \\ - j & 0 \\ 0 & 1\end{matrix} ]$ | $\frac{1}{2} [ \begin{matrix}1 & 0 \\ 0 & 1 \\ - j & 0 \\ 0 & - 1\end{matrix} ]$ | $\frac{1}{2} [ \begin{matrix}1 & 0 \\ 0 & 1 \\ - 1 & 0 \\ 0 & - j\end{matrix} ]$ | $\frac{1}{2} [ \begin{matrix}1 & 0 \\ 0 & 1 \\ - 1 & 0 \\ 0 & j\end{matrix} ]$ |
| 12-15 | $\frac{1}{2} [ \begin{matrix}1 & 0 \\ 0 & 1 \\ j & 0 \\ 0 & 1\end{matrix} ]$ | $\frac{1}{2} [ \begin{matrix}1 & 0 \\ 0 & 1 \\ j & 0 \\ 0 & - 1\end{matrix} ]$ | $\frac{1}{2 \sqrt{2}} [ \begin{matrix}1 & 1 \\ 1 & 1 \\ 1 & - 1 \\ 1 & 1\end{matrix} ]$ | $\frac{1}{2 \sqrt{2}} [ \begin{matrix}1 & 1 \\ 1 & 1 \\ j & - j \\ j & - j\end{matrix} ]$ |
| 16-19 | $\frac{1}{2 \sqrt{2}} [ \begin{matrix}1 & 1 \\ j & j \\ 1 & - 1 \\ j & - j\end{matrix} ]$ | $\frac{1}{2 \sqrt{2}} [ \begin{matrix}1 & 1 \\ j & j \\ j & - j \\ - 1 & 1\end{matrix} ]$ | $\frac{1}{2 \sqrt{2}} [ \begin{matrix}1 & 1 \\ - 1 & - 1 \\ 1 & - 1 \\ - 1 & 1\end{matrix} ]$ | $\frac{1}{2 \sqrt{2}} [ \begin{matrix}1 & 1 \\ - 1 & - 1 \\ j & - j \\ - j & j\end{matrix} ]$ |
| 20-21 | $\frac{1}{2 \sqrt{2}} [ \begin{matrix}1 & 1 \\ - j & - j \\ 1 & - 1 \\ - j & j\end{matrix} ]$ | $\frac{1}{2 \sqrt{2}} [ \begin{matrix}1 & 1 \\ - j & - j \\ j & - j \\ 1 & - j\end{matrix} ]$ | — | — |

TABLE 6
Codebook used for 4-antenna port, 3-layer transmission, and CP-OFDM

| | W | | | |
|---|---|---|---|---|
| TPMI index | (ordered from left to right in increasing order of TPMI index) | | | |
| 0-3 | $\frac{1}{2} [ \begin{matrix}1 & 0 & 0 \\ 0 & 1 & 0 \\ 0 & 0 & 1 \\ 0 & 0 & 0\end{matrix} ]$ | $\frac{1}{2} [ \begin{matrix}1 & 0 & 0 \\ 0 & 1 & 0 \\ 1 & 0 & 0 \\ 0 & 0 & 1\end{matrix} ]$ | $\frac{1}{2} [ \begin{matrix}1 & 0 & 0 \\ 0 & 1 & 0 \\ - 1 & 0 & 0 \\ 0 & 0 & 1\end{matrix} ]$ | $\frac{1}{2 \sqrt{3}} [ \begin{matrix}1 & 1 & 1 \\ 1 & - 1 & 1 \\ 1 & 1 & - 1 \\ 1 & - 1 & - 1\end{matrix} ]$ |
| 4-6 | $\frac{1}{2 \sqrt{3}} [ \begin{matrix}1 & 1 & 1 \\ 1 & - 1 & 1 \\ j & j & - j \\ j & - j & - j\end{matrix} ]$ | $\frac{1}{2 \sqrt{3}} [ \begin{matrix}1 & 1 & 1 \\ - 1 & 1 & - 1 \\ 1 & 1 & - 1 \\ - 1 & 1 & 1\end{matrix} ]$ | $\frac{1}{2 \sqrt{3}} [ \begin{matrix}1 & 1 & 1 \\ - 1 & 1 & - 1 \\ j & j & - j \\ - j & j & j\end{matrix} ]$ | — |

TABLE 7
Codebook used for 4-antenna port, 4-layer transmission, and CP-OFDM

| | W | | | |
|---|---|---|---|---|
| TPMI index | (ordered from left to right in increasing order of TPMI index) | | | |
| 0-3 | $\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$ | $\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ]$ | $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$ | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ |
| 4 | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ | — | — | — |

It should be noted that if a relative phase change in the signals transmitted on the antenna ports is within a certain range, the SRS ports may be said to be coherent (or phase-consistent).

In some implementations, a coherence metric (or requirement) for the antenna ports described above may be defined in a protocol or configured by the network device. For example, the metric may be defined by thresholds p and m. As another example, the metric may be defined by a duration t and the threshold p/m.

Illustratively, the coherence metric may include: if the relative phase change does not exceed the threshold p and a relative power error does not exceed m, the coherence metric is satisfied; otherwise, the coherent metric is not satisfied.

Illustratively, the coherence metric may be: if the relative phase change within the duration t does not exceed the threshold p and the relative power error does not exceed the threshold m, the coherence metric is satisfied; otherwise, the coherent metric is not satisfied. For example, if the relative phase change in the signals transmitted by the transmitting antennas or antenna ports of the terminal device within a duration of 20 ms does not exceed 40 degrees and the power error does not exceed 4 db, the signals on the antenna ports satisfies the coherence metric.

Therefore, it can be seen that the related art supports codebook-based precoding processing for two antenna ports and four antenna ports. However, some terminal devices have three transmission antennas. Because the related art cannot support the codebook-based precoding processing for three antenna ports, these terminal devices have to degrade to two antenna ports for transmission, that is, a 2-port codebook is used for uplink transmission. The gain of the three transmission antennas cannot be fully utilized, resulting in a spectral efficiency being affected. If the uplink transmission for the three antenna ports is to be supported, corresponding SRS resources supporting the three antenna ports are required for uplink channel sounding. However, the relevant protocols only support SRS resources for 1, 2, 4, or 8 antenna ports. The introduction of additional SRS resources for the three antenna ports requires significant standardization work, such as addressing issues like how to determine a comb configuration, cyclic shift configuration, physical resources, sequence, etc. for the three SRS ports.

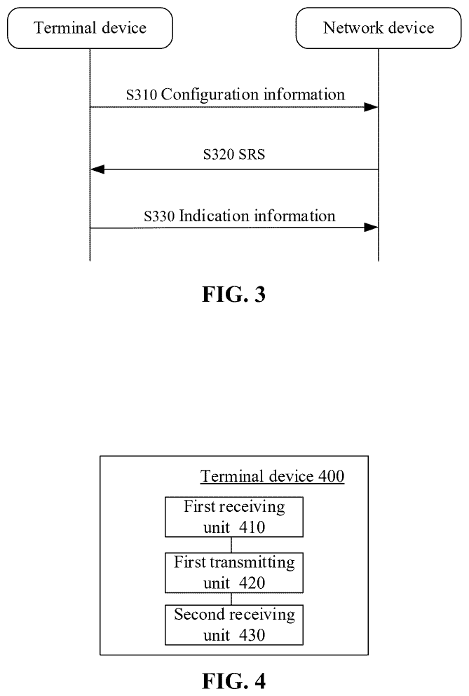

FIG. 3 is a schematic flowchart of a wireless communication method provided by an embodiment of the disclosure to solve the above problems. The method illustrated in FIG. 3 may be performed by a terminal device and a network device. The method illustrated in FIG. 3 may include operations S310 to S330.

At S310, the terminal device receives configuration information from the network device.

The configuration information may be used for configuring a first SRS resource group and a second SRS resource group. The first SRS resource group may include one or more SRS resources for two antenna ports. The second SRS resource group may include one or more SRS resources for a single antenna port. In other words, the configuration information may be used for configuring the SRS resource for the two antenna ports and the SRS resource for the single antenna port.

A message carrying the configuration information is not limited in the disclosure. For example, the configuration information may be carried in a radio resource control (RRC) message.

At S320, the terminal device transmits SRSs to the network device on the first SRS resource group and the second SRS resource group.

At S330, the network device transmits indication information to the terminal device.

The indication information may indicate TPMI information. The TPMI information is used for determining a precoding scheme on antenna ports corresponding to a first SRS resource and a second SRS resource. The first SRS resource group includes the first SRS resource. The second SRS resource group includes the second SRS resource. The TPMI information may be determined by the network device through the received SRSs.

A message carrying the indication information is not limited in the disclosure. For example, the indication information may be indicated by DCI.

Illustratively, the terminal device may determine the TPMI information based on the received indication information, and determine the precoding scheme on the antenna ports corresponding to the first SRS resource and the second SRS resource.

According to the disclosure, uplink channel information measured through a combination of the first SRS resource and the second SRS resource may be used to schedule the same uplink channel or signal (e.g., the same PUSCH), thereby supporting uplink PUSCH transmission based on three antenna ports. For example, an equivalent SRS resource for the three antenna ports may be formed by combining an SRS resource for the two antenna ports and an SRS resource for the single antenna port. Compared with the two antenna ports, supporting the uplink transmission with the three antenna ports can significantly improve uplink spectral efficiency. Furthermore, the SRS resource for the three antenna ports may be formed in the disclosure based on the SRS resource for the two antenna ports and the SRS resource for the single antenna port in the related art. Therefore, three-port transmission can be implemented with lower standardization complexity and without introducing a new SRS resource for the three antenna ports.

In some embodiments, the first SRS resource group and the second SRS resource group may be two SRS resource groups in a same SRS resource set. Alternatively, the first SRS resource group and the second SRS resource group may belong to two different SRS resource sets.

It should be noted that for an SRS resource set, a portion of SRS parameters may be configured to the SRS resource set instead of being configured separately for each SRS resource, so that the SRS resources in the same SRS resource set may share the SRS parameters. The portion of the SRS parameters may include one or more of: a slot configuration, a power control parameter, and the like. Therefore, when the first SRS resource group and the second SRS resource group belong to the same SRS resource set, the SRS resource in the first SRS resource group and the SRS resource in the second SRS resource group may share the portion of the SRS parameters.

In some embodiments, some parameters of the SRS resource in the first SRS resource group may be identical to those of the SRS resource in the second SRS resource group, so that the uplink channel information measured based on the two SRS resource groups may be used to schedule the same PUSCH.

Optionally, one or more of following configurations for the SRS resource in the first SRS resource group and for the SRS resource in the second SRS resource group may be the same: a frequency domain resource, a slot configuration, an OFDM symbol configuration, a frequency domain hopping configuration, a sequence hopping configuration, a cyclic shift hopping configuration, a comb offset hopping configuration, or a power control parameter. Hereinafter, each of them will be described.

The frequency domain resource may be used for configuring a physical resource block (PRB) for SRS transmission. When the frequency domain resource for the SRS resources in the first SRS resource group is identical to the frequency domain resource for the SRS resource in the second SRS resource group, the two SRS resource groups may adopt the same PRB for transmitting the SRS.

The slot configuration may be used for configuring a slot where the SRS resource is located. When the slot configuration for the SRS resource in the first SRS resource group is identical to the slot configuration for the SRS resource in the second SRS resource group, the two SRS resource groups may adopt the same slot for transmitting the SRS.

The OFDM symbol configuration may be used for configuring an OFDM symbol where the SRS resource is located. When the OFDM symbol configuration for the SRS resource in the first SRS resource group is identical to the OFDM symbol configuration for the SRS resource in the second SRS resource group, the two SRS resource groups may adopt the same OFDM symbol for transmitting the SRS.

The frequency domain hopping configuration may be used for configuring a frequency domain hopping parameter for the SRS resource. When the frequency domain hopping for the SRS resource in the first SRS resource group is identical to the frequency domain hopping for the SRS resources in the second SRS resource group, the two SRS resource groups may adopt the same frequency domain hopping.

The sequence hopping configuration may be used for configuring a sequence hopping parameter for an SRS sequence. When the sequence hopping for the SRS resource in the first SRS resource group is identical to the sequence hopping for the SRS resource in the second SRS resource group, the two SRS resource groups may adopt the same sequence hopping to obtain the same base sequence.

The cyclic shift hopping configuration may be used for configuring a cyclic shift hopping parameter for the SRS resource. When the cyclic shift hopping for the SRS resource in the first SRS resource group is identical to the cyclic shift hopping for the SRS resource in the second SRS resource group, the two SRS resource groups may adopt the same cyclic shift hopping.

The comb offset hopping configuration may be used for configuring a comb offset hopping parameter for the SRS resource. When the comb offset hopping for the SRS resource in the first SRS resource group is identical to the comb offset hopping for the SRS resource in the second SRS resource group, the two SRS resource groups may adopt the same comb offset hopping to obtain the same comb offset.

The power control parameter may be used for configuring the power control parameter for the SRS resource. When the power control parameter for the SRS resource in the first SRS resource group is identical to the power control parameter for the SRS resource in the second SRS resource group, the two SRS resource groups may adopt the same transmission power for transmitting the SRS.

In some embodiments, each SRS resource in the first SRS resource group may correspond to (or have a correspondence with) at least one SRS resource in the second SRS resource group. The disclosure provides a first method and a second method for implementing the correspondence between the SRS resources, and will be described below respectively.

In the first method, the first SRS resource group and the second SRS resource group may include the same number of SRS resources, and each of the SRS resources in the first SRS resource group corresponds to a respective one of the SRS resources in the second SRS resource group. For example, the n-th SRS resource in the first SRS resource group corresponds to the n-th SRS resource in the second SRS resource group, where n may be a positive integer.

In the second method, the first SRS resource group and the second SRS resource group may include different numbers of SRS resources, and an SRS resource in the first SRS resource group corresponds to an SRS resource in the second SRS resource group (referred to as an SRS resource pair). One SRS resource may correspond to multiple resources (that is, the SRS resource may be combined with the multiple resources to form an SRS resource for three antenna ports for use).

For example, if the first SRS resource group includes N (N>1) SRS resources for two ports and the second SRS resource group includes an SRS resource for a single port, each SRS resource for the two ports may correspond to the SRS resource for the single port.

For another example, if the first SRS resource group includes N (N>1) SRS resources for the two ports and the second SRS resource group includes M (M>1) SRS resources for the single port, the correspondence between the SRS resources may be configured by the network device or specified by a protocol. Here, N may be different from M. For example, the SRS resource 1 in the first SRS resource group may correspond to the SRS resource 3 in the second SRS resource group, the SRS resource 2 in the first SRS resource group may correspond to the SRS resource 5 in the second SRS resource group, and the like.

In an implementation, the two corresponding SRS resources include two antenna ports and a single antenna port, respectively, and may be used to transmit the SRS with three antenna ports. That is, an equivalent SRS resource for the three antenna ports may be formed by the SRS resource for the two antenna ports and the SRS resource for the single antenna port.

It should be noted that the two corresponding SRS resources may satisfy one or more of: occupying the same physical resource, using the same transmission beam, or using the same transmission power, so that the equivalent SRS for the three antenna ports may be used for scheduling the same PUSCH. The physical resources may include a time domain resource and/or a frequency domain resource. The same transmission beam may be referred to as the same spatial domain transmission filter, or the same antenna port.

As described above, the network device may determine the TPMI information from the received SRSs. Illustratively, the network device may determine a precoding matrix from a predefined codebook for the three antenna ports based on channel information obtained from the SRSs from the three antenna ports, and use an index of the matrix as the TPMI information. The SRSs from the three antenna ports are obtained by combining the SRSs respectively transmitted on the two corresponding SRS resources. That is, the network device may combine the channels on the two ports and the channel on the single port measured on the two corresponding SRS resources, respectively, to obtain the channels on the three antenna ports.

As described above, the TPMI information may be used for determining a precoding matrix on the antenna ports corresponding to the first SRS resource and the second SRS resource. The first SRS resource and the second SRS resource may satisfy the above-described correspondence relationship. When the first SRS resource corresponds to the second SRS resource, how to determine the precoding matrix on the antenna ports corresponding to the first SRS resource and the second SRS resource based on the indication of the TPMI information will be described below as an example.

In some embodiments, the terminal device may determine a precoding matrix for the three antenna ports based on the TPMI information. The three antenna ports are composed of the two antenna ports corresponding to the first SRS resource and the single antenna port corresponding to the second SRS resource. The precoding matrix for the three antenna ports may be predefined.

Illustratively, the TPMI information may indicate a TPMI index. The terminal device may determine a precoding matrix from the codebook for the three antenna ports based on the TPMI index. The codebook for the three antenna ports will be illustrated below.

In an implementation, the codebook may be a non-coherent codebook (available for non-coherent antenna ports). In this case, the codebook may contain the following codewords:

$$\frac{1}{\sqrt{3}} [ \begin{matrix}1 \\ 0 \\ 0\end{matrix} ] \frac{1}{\sqrt{3}} [ \begin{matrix}0 \\ 1 \\ 0\end{matrix} ] \frac{1}{\sqrt{3}} [ \begin{matrix}0 \\ 0 \\ 1\end{matrix} ] \frac{1}{\sqrt{3}} [ \begin{matrix}1 & 0 \\ 0 & 1 \\ 0 & 0\end{matrix} ] \frac{1}{\sqrt{3}} [ \begin{matrix}1 & 0 \\ 0 & 0 \\ 0 & 1\end{matrix} ] \frac{1}{\sqrt{3}} [ \begin{matrix}0 & 0 \\ 1 & 0 \\ 0 & 1\end{matrix} ] \frac{1}{\sqrt{3}} [ \begin{matrix}1 & 0 & 0 \\ 0 & 1 & 0 \\ 0 & 0 & 1\end{matrix} ] .$$

In another implementation, the codebook may be a partially coherent codebook (available for partially coherent antenna ports). In this case, the codebook may contain the following codewords:

$$Rank = 1 \text{:} \{ \frac{1}{\sqrt{3}} [ \begin{matrix}1 \\ 1 \\ 0\end{matrix} ] , \frac{1}{\sqrt{3}} [ \begin{matrix}1 \\ - 1 \\ 0\end{matrix} ] , \frac{1}{\sqrt{3}} [ \begin{matrix}1 \\ j \\ 0\end{matrix} ] , \frac{1}{\sqrt{3}} [ \begin{matrix}1 \\ − j \\ 0\end{matrix} ] \} ;$$

$$Rank = 2 \text{:} \{ \frac{1}{\sqrt{6}} [ \begin{matrix}1 & 1 \\ 1 & − 1 \\ 0 & 0\end{matrix} ] , \frac{1}{\sqrt{6}} [ \begin{matrix}1 & 1 \\ j & − j \\ 0 & 0\end{matrix} ] , \frac{1}{\sqrt{3}} [ \begin{matrix}1 & 0 \\ 1 & 0 \\ 0 & 1\end{matrix} ] , \frac{1}{\sqrt{3}} [ \begin{matrix}1 & 0 \\ − 1 & 0 \\ 0 & 1\end{matrix} ] , \frac{1}{\sqrt{3}} [ \begin{matrix}1 & 0 \\ j & 0 \\ 0 & 1\end{matrix} ] , \frac{1}{\sqrt{3}} [ \begin{matrix}1 & 0 \\ − j & 0 \\ 0 & 1\end{matrix} ] \} ;$$

$$Rank = 3 : \{ \frac{1}{\sqrt{5}} [ \begin{matrix}1 & 1 & 0 \\ 1 & - 1 & 0 \\ 0 & 0 & 1\end{matrix} ] , \frac{1}{\sqrt{5}} [ \begin{matrix}1 & 1 & 0 \\ j & - j & 0 \\ 0 & 0 & 1\end{matrix} ]$$

Therefore, the TPMI information may include a TPMI that may be used for determining a precoding matrix for the three antenna ports, and this scheme requires a codebook for the three antenna ports.

Optionally, the terminal device may perform precoding on the uplink data using the precoding matrix for the three antenna ports indicated by the TPMI, and transmit the precoded uplink data on the three antenna ports composed of the two antenna ports corresponding to the first SRS resource and the single antenna port corresponding to the second SRS resource.

In some embodiments, the TPMI information may include a first TPMI and a second TPMI. The first TPMI may be used for determining a precoding scheme on an antenna port corresponding to the first SRS resource, and the second TPMI may be used for determining a precoding scheme on an antenna port corresponding to the second SRS resource. The network device may determine the first TPMI based on the channel information measured from the first SRS resource, and determine the second TPMI based on the channel information measured from the second SRS resource. Thus, the first TPMI is associated with the first SRS resource group, and the second TPMI is associated with the second SRS resource group.

It can be understood that, in these embodiments, two sets of antenna ports may be configured for transmission independently, to transmit the SRSs on the two antenna ports and the SRS on the single antenna port, respectively, and independent SRI/PMI may be used to indicate the SRS resource. Therefore, the codebook for the three antenna ports may not be introduced.

The first TPMI may indicate whether the antenna ports corresponding to the first SRS resource are used for data transmission, and/or the first TPMI may indicate a precoding matrix for the two antenna ports.

In an implementation, the first TPMI may include 2-bit information. Two bits in the 2-bit information may indicate whether the two antenna ports corresponding to the first SRS resource are used for data transmission, respectively. For example, the first bit may indicate whether the first antenna port is used for data (e.g., PUSCH) transmission, and the second bit may indicate whether the second antenna port is used for data (e.g., PUSCH) transmission. If both bits are 0, it may indicate that neither of the two antenna ports corresponding to the first SRS resource is used for data transmission.

In an implementation, the first TPMI may include 2-bit information. The 2-bit information may indicate a precoding matrix for the two antenna ports. Further, the 2-bit information may indicate that neither of the two antenna ports corresponding to the first SRS resource is used for data transmission, that is, the precoding matrix is

$$\frac{1}{\sqrt{3}} [ \begin{matrix}0 \\ 0\end{matrix} ] .$$

For example, for a non-coherent terminal, the 2-bit information may indicate one of: the precoding matrix is

$$\frac{1}{\sqrt{3}} [ \begin{matrix}1 \\ 0\end{matrix} ] ;$$

the precoding matrix is

$$\frac{1}{\sqrt{3}} [ \begin{matrix}0 \\ 1\end{matrix} ] ;$$

the precoding matrix is

$$\frac{1}{\sqrt{3}} [ \begin{matrix}1 & 0 \\ 0 & 1\end{matrix} ] ;$$

or the two antenna ports are not used for data transmission.

For example, the correspondence between the values of the two bits in the first TPMI and the indicated information may be: 00 indicates the precoding matrix

$$\frac{1}{\sqrt{3}} [ \begin{matrix}1 \\ 0\end{matrix} ] ;$$

01 indicates the precoding matrix

$$\frac{1}{\sqrt{3}} [ \begin{matrix}0 \\ 1\end{matrix} ] ;$$

10 indicates the precoding matrix

$$\frac{1}{\sqrt{3}} [ \begin{matrix}1 & 0 \\ 0 & 1\end{matrix} ] ;$$

and 11 indicates that the two antenna ports are not used for data transmission. It should be noted that this correspondence is merely an example, and an actual indication value and an indication content may be exchanged. For example, 00 may indicate that the two antenna ports are not used for data transmission. In addition,

$$\frac{1}{\sqrt{3}}$$

here is a power normalization coefficient, which is used to ensure the power normalization when three antenna ports are used at the same time.

In an implementation, the first TPMI may include more than 2 bits of information (e.g., 4 bits) for indicating a precoding matrix for the two antenna ports. The precoding matrix may be used for a terminal device employing fully coherent antennas. For example, the information may indicate that: the precoding matrix is:

$$\frac{1}{\sqrt{3}} [ \begin{matrix}1 \\ 1\end{matrix} ] , \frac{1}{\sqrt{3}} [ \begin{matrix}1 \\ − 1\end{matrix} ] , \frac{1}{\sqrt{3}} [ \begin{matrix}1 \\ j\end{matrix} ] , \frac{1}{\sqrt{3}} [ \begin{matrix}1 \\ − j\end{matrix} ] , \frac{1}{\sqrt{3}} [ \begin{matrix}1 \\ 0\end{matrix} ] , \frac{1}{\sqrt{3}} [ \begin{matrix}0 \\ 1\end{matrix} ] , \frac{1}{\sqrt{6}} [ \begin{matrix}1 & 1 \\ 1 & − 1\end{matrix} ] , \frac{1}{\sqrt{6}} [ \begin{matrix}1 & 1 \\ j & − j\end{matrix} ] or \frac{1}{\sqrt{3}} [ \begin{matrix}1 & 0 \\ 0 & 1\end{matrix} ] ;$$

or the two antenna ports are not used for data transmission. Herein,

$$\frac{1}{\sqrt{3}} and \frac{1}{\sqrt{6}}$$

are power normalization coefficients, which are used to ensure power normalization when three antenna ports are used at the same time.

The second TPMI may indicate whether the antenna port corresponding to the second SRS resource is used for data transmission. Illustratively, the second TPMI may be only 1 bit for indicating whether the antenna port is used for data transmission. For example, 0 may indicate that the antenna port is not used for data transmission, and 1 may indicate that the antenna port is used for data transmission. As another example, 1 may indicate that the antenna port is not used for data transmission, and 0 may indicate that the antenna port is used for data transmission.

In some embodiments, each of the first TPMI and the second TPMI may indicate a number of transmission layers on the antenna ports corresponding to the first SRS resource and the second SRS resource respectively.

For example, for the first TPMI, if the first TPMI indicates whether two antenna ports corresponding to the first SRS resource are used for data transmission, the number of transmission layers on the antenna ports corresponding to the first SRS resource may be the number of antenna ports used for data transmission (0, 1, or 2). If the first TPMI indicates a precoding matrix for the two antenna ports, the number of transmission layers on the antenna ports corresponding to the first SRS resource may be the number of columns in the precoding matrix. For the second TPMI, if the second TPMI indicates that the antenna port corresponding to the second SRS resource is used for data transmission, the number of transmission layers corresponding to the second SRS resource may be 1. If the second TPMI indicates that the antenna port corresponding to the second SRS resource is not used for data transmission, the number of transmission layers corresponding to the second SRS resource may be 0.

Optionally, the total number of transmission layers for the uplink data (i.e., a rank value in the uplink) may be equal to the sum of the number of transmission layers indicated by the first TPMI and the number of transmission layers indicated by the second TPMI.

It should be noted that the first TPMI and the second TPMI are not allowed to both indicate that the corresponding antenna ports are not used for data transmission, or the number of transmission layers indicated by the first TPMI and the number of transmission layers indicated by the second TPMI are not allowed to both be 0, so as to avoid a situation where no antenna port is available for transmitting the scheduled uplink data.

In some embodiments, the terminal device may transmit first information and second information to the network device.

The first information may indicate whether the two antenna ports corresponding to the first SRS resource are capable of supporting full power transmission. The second information may indicate whether the single antenna port corresponding to the second SRS resource is capable of supporting full power transmission.

For example, the first information may include 2 bits indicating whether the first antenna port and the second antenna port, respectively, are capable of supporting full power transmission, so that the network device may schedule the respective antenna ports to achieve greater transmission power. Illustratively, 10 may indicate that the first antenna port supports full power transmission; and 00 may indicate that neither of the two antenna ports supports full power transmission, but both antenna ports together support full power transmission when transmitting simultaneously.

For another example, the second information may include 1 bit indicating whether the single antenna port corresponding to the second SRS resource is capable of supporting full power transmission. Illustratively, 0 may indicate that full power transmission is not supported, and 1 may indicate that full power transmission is supported.

In some embodiments, the terminal device may receive SRI information from the network device. The SRI information may be used for determining the first SRS resource and the second SRS resource from the first SRS resource group and the second SRS resource group, respectively.

It should be noted that, if the first SRS resource group and the second SRS resource group each includes only one SRS resource, that is, the first SRS resource and the second SRS resource, respectively, the network device may not transmit the SRI information, and the terminal device may not receive the SRI information. If the first SRS resource group or the second SRS resource group include a plurality of SRS resources, the network device may transmit the SRI information, the terminal device may receive the SRI information configured by the network device, and the terminal device may determine the first SRS resource and the second SRS resource from the first SRS resource group and/or the second SRS resource group, respectively, based on the SRI information.

For the first SRS resource group or the second SRS resource group, the network device may select an optimal SRS resource based on received signal strength of different SRS resources in the SRS resource group, and use an index corresponding to the SRS resource as the SRI information.

An indication method for the SRI information is not limited in the disclosure, for example, the SRI may be indicated by the same DCI together with the TPMI. As a possible implementation, the SRI information may include a first SRI and/or a second SRI, and the two SRIs may indicate different values. The first SRI may be used for determining the first SRS resource from the first SRS resource group, and the second SRI may be used for determining the second SRS resource from the second SRS resource group. That is, the first SRI may be associated with the first SRS resource group, and the second SRI may be associated with the second SRS resource group.

It should be noted that, the first SRI and the second SRI may not necessarily exist at the same time. When the first SRS resource group includes a plurality of SRS resources, the SRI information may include the first SRI. When the second SRS resource group includes a plurality of SRS resources, the SRI information may include the second SRI. When the TPMI information includes the first TPMI and the second TPMI, the first SRI is used for determining the first SRS resource, and the first TPMI is used for determining the precoding scheme on the antenna ports corresponding to the first SRS resource, so the first SRI and the first TPMI are two pieces of information associated with each other. Similarly, the second SRI is used for determining the second SRS resource, and the second TPMI is used for determining the precoding scheme on the antenna port corresponding to the second SRS resource, so the second SRI and the second TPMI are two pieces of information associated with each other.

As another possible implementation, the SRI information may include only one SRI, and the terminal device determines the first SRS resource and the second SRS resource with the same index from the two SRS resource groups, respectively, based on the SRI. When the SRI information indicates the index n−1, the first SRS resource may correspond to the n-th SRS resource in the first SRS resource group, and the second SRS resource may correspond to the n-th SRS resource in the second SRS resource group. Herein n may be a positive integer. This implementation may be applied to a case where the first SRS resource group and the second SRS resource group include the same number of SRS resources, and each of the SRS resources in the first SRS resource group corresponds to a respective one of the SRS resources in the second SRS resource group.

As another possible implementation, in a case where an SRS resource in the first SRS resource group corresponds to an SRS resource in the second SRS resource group described above, the SRI information may indicate an SRS resource pair from among the SRS resource pairs configured by the network device. Each SRS resource pair configured in advance by the network device includes an SRS resource in the first SRS resource group and an SRS resource in the second SRS resource group, respectively.

In some embodiments, after determining the precoding scheme, the terminal device may perform precoding on the uplink data based on the precoding scheme, and transmit the precoded data to the network device on the antenna ports corresponding to the first SRS resource and the second SRS resource.

Optionally, respective transmission layers in the uplink data may be mapped to different antenna ports among the antenna ports corresponding to the first SRS resource and the second SRS resource. That is, up to three transmission layers may be transmitted in the uplink, each transmission layer is mapped to a respective antenna port, and the unmapped antenna port may not be used for uplink transmission.

In an implementation, when the antenna ports corresponding to the first SRS resource and the antenna port corresponding to the second SRS resource are all used for transmitting uplink data, the respective transmission layers in the uplink data may be mapped to the antenna port corresponding to the first SRS resource first, and then mapped to the antenna port corresponding to the second SRS resource.

For example, when the number of transmission layers is 2 and the antenna ports corresponding to the two SRS resources each transmits a respective transmission layer, the first transmission layer may be mapped to the antenna port corresponding to the first SRS resource first, and then the second transmission layer may be mapped to the antenna port corresponding to the second SRS resource. When the number of transmission layers is 3, the first two transmission layers may be mapped to the antenna ports corresponding to the first SRS resource, and then the third transmission layer may be mapped to the antenna port corresponding to the second SRS resource.

When the first SRS resource and the second SRS resource correspond to different SRIs or TPMIs (for example, the first SRS resource corresponds to the first TPMI and the second SRS resource corresponds to the second TPMI), the disclosure proposes that when the SRI information indicates two SRIs and/or the TPMI information indicates two TPMIs, the transmission layer in the uplink data may first correspond to the first SRI (the first SRI is used for the transmission layer), and then correspond to the second SRI (the second SRI is used for the transmission layer); or the transmission layer in the uplink data may first correspond to the first TPMI (the first TPMI is used for the transmission layer), and then correspond to the second TPMI (the second TPMI is used for the corresponding transmission layer). For example, when the number of transmission layers is 3, the first TPMI is used for the first two transmission layers, and the second TPMI is used for the third transmission layer.

In another implementation, when the antenna ports corresponding to the first SRS resource and the antenna port corresponding to the second SRS resource are all used for transmitting uplink data, the respective transmission layers in the uplink data may be mapped to the antenna port corresponding to the second SRS resource first, and then mapped to the antenna port corresponding to the first SRS resource.

For example, when the number of transmission layers is 3, the first transmission layer may be mapped to the antenna port corresponding to the second SRS resource first, and the latter two transmission layers may be mapped to the antenna ports corresponding to the first SRS resource.

When the first SRS resource and the second SRS resource correspond to different SRIs or TPMIs (for example, the first SRS resource corresponds to the first TPMI, and the second SRS resource corresponds to the second TPMI), the disclosure proposes that when the SRI information indicates two SRIs and/or the TPMI information indicates two TPMIs, the transmission layer in the uplink data may first correspond to the second SRI (the second SRI is used for the transmission layer), and then correspond to the first SRI (the first SRI is used for the transmission layer); or the transmission layer in the uplink data may first correspond to the second TPMI (the second TPMI is used for the transmission layer) and then correspond to the first TPMI (the first TPMI is used for the corresponding transmission layer). For example, when the number of transmission layers is 3, the first TPMI may be used for the latter two transmission layers, and the second TPMI may be used for the first transmission layer.

For ease of understanding, the disclosure will be described in detail below with reference to the first embodiment and the second embodiment.

### The First Embodiment

The method provided by the first embodiment may include operations 1.1 to 1.5.

At operation 1.1, a network device transmits configuration information to a terminal device. Correspondingly, the terminal device receives the configuration information from the network device. The configuration information is used for configuring a first SRS resource group and a second SRS resource group.

The first SRS resource group includes one or more SRS resources for two antenna ports, and the second SRS resource group includes one or more SRS resources for a single antenna port.

The first SRS resource group and the second SRS resource group are two SRS resource groups in the same SRS resource set, or the first SRS resource group and the second SRS resource group are two different SRS resource sets. Specifically, a portion of the SRS parameters may be configured to the SRS resource set instead of being configured separately for each SRS resource, so that the SRS resources in the same SRS resource set may share these parameters, such as a slot configuration, a power control parameter, and the like.

Some parameters of the SRS resource in the first SRS resource group may be identical to those of the SRS resource in the second SRS resource group, so that the uplink channel information measured based on the two SRS resource groups may be used to schedule the same PUSCH. Herein, at least one of the following parameter configurations may be the same: a frequency domain resource, a slot configuration, an OFDM symbol configuration, a frequency domain hopping configuration, a sequence hopping configuration, a cyclic shift hopping configuration, a comb offset hopping configuration, or a power control parameter.

Optionally, each SRS resource in the first SRS resource group may correspond to at least one SRS resource in the second SRS resource group. The correspondence may be implemented through a first method or a second method.

In the first method, the first SRS resource group and the second SRS resource group may include the same number of SRS resources, and each of the SRS resources in the first SRS resource group corresponds to a respective one of the SRS resources in the second SRS resource group. For example, the n-th SRS resource in the first SRS resource group corresponds to the n-th SRS resource in the second SRS resource group.

In the second method, the first SRS resource group and the second SRS resource group may include different numbers of SRS resources, and an SRS resource in the first SRS resource group corresponds to an SRS resource in the second SRS resource group (referred to as an SRS resource pair). One SRS resource may correspond to multiple resources (that is, the SRS resource may be combined with the multiple resources to form an SRS resource for three antenna ports for use).

For example, the first SRS resource group includes N>1 SRS resources for two ports, the second SRS resource group includes an SRS resource for a single port, and each SRS resource for the two ports may correspond to the SRS resource for the single port.

For another example, the first SRS resource group includes N>1 SRS resources for the two ports, and the second SRS resource group includes M>1 SRS resources for the single port. The correspondence between the SRS resources may be configured by the network device to the terminal, for example, the SRS resource 1 in the first SRS resource group corresponds to the SRS resource 3 in the second SRS resource group, the SRS resource 2 in the first SRS resource group corresponds to the SRS resource 5 in the second SRS resource group, and the like.

In an implementation, the two corresponding SRS resources include two antenna ports and a single antenna port, respectively, and may be used to transmit the SRS with three antenna ports. That is, an equivalent SRS resource for the three antenna ports may be formed by the SRS resource for the two antenna ports and the SRS resource for the single antenna port.

In order for the equivalent SRS resource for the three antenna ports to be used for the scheduling of the same PUSCH, the two corresponding SRS resources satisfy one or more of: occupying the same physical resource, using the same transmission beam, or using the same transmission power.

At operation 1.2, the terminal device transmits SRSs on the first SRS resource group and the second SRS resource group. Correspondingly, the network device receives the SRSs transmitted by the terminal device on the first SRS resource group and the second SRS resource group.

At operation 1.3, the network device determines TPMI information based on the received SRSs, and transmits indication information to the terminal device. The indication information includes the TPMI information.

For example, the network device may determine a precoding matrix from a predefined codebook for the three antenna ports based on channel information obtained from the SRSs from the three antenna ports, and use an index of the matrix as the TPMI information. The SRSs from the three antenna ports are obtained by combining the SRSs respectively transmitted on the two corresponding SRS resources. That is, the network device may combine the channels on the two ports and the channel on the single port measured on the two corresponding SRS resources, respectively, to obtain the channels on the three antenna ports.

Further, if the first SRS resource group or the second SRS resource group includes a plurality of SRS resources, the network device may further determine SRI information based on the received SRSs. The network device may select an optimal SRS resource based on the received signal strength of different SRS resources in the SRS resource group, and use the index corresponding to the SRS resource as the SRI information.

At operation 1.4, the terminal device receives TPMI information configured by the network device, and determines a precoding scheme on antenna ports corresponding to a first SRS resource and a second SRS resource based on the TPMI information. The first SRS resource group includes the first SRS resource, the second SRS resource group includes the second SRS resource, and the first SRS resource and the second SRS resource satisfy the correspondence in the operation 1.1.

The terminal device may determine a precoding matrix for the three antenna ports based on the TPMI information, and the three antenna ports are composed of the two antenna ports corresponding to the first SRS resource and the single antenna port corresponding to the second SRS resource. The TPMI information indicates a TPMI index, and the terminal device may determine, based on the index, the precoding matrix from the predefined codebook for the three antenna ports.

In an implementation, the codebook is a non-coherent codebook (i.e., available for non-coherent antenna ports), and the codebook may include the following codewords:

$$\frac{1}{\sqrt{3}} [ \begin{matrix}1 \\ 0 \\ 0\end{matrix} ] \frac{1}{\sqrt{3}} [ \begin{matrix}0 \\ 1 \\ 0\end{matrix} ] \frac{1}{\sqrt{3}} [ \begin{matrix}0 \\ 0 \\ 1\end{matrix} ] \frac{1}{\sqrt{3}} [ \begin{matrix}1 & 0 \\ 0 & 1 \\ 0 & 0\end{matrix} ] \frac{1}{\sqrt{3}} [ \begin{matrix}1 & 0 \\ 0 & 0 \\ 0 & 1\end{matrix} ] \frac{1}{\sqrt{3}} [ \begin{matrix}0 & 0 \\ 1 & 0 \\ 0 & 1\end{matrix} ] \frac{1}{\sqrt{3}} [ \begin{matrix}1 & 0 & 0 \\ 0 & 1 & 0 \\ 0 & 0 & 1\end{matrix} ] .$$

In another implementation, the codebook is a partially coherent codebook (i.e., available for partially coherent antenna ports), and the codebook may include the following codewords:

$$Rank = 1 : \{ \frac{1}{\sqrt{3}} [ \begin{matrix}1 \\ 1 \\ 0\end{matrix} ] , \frac{1}{\sqrt{3}} [ \begin{matrix}1 \\ - 1 \\ 0\end{matrix} ] , \frac{1}{\sqrt{3}} [ \begin{matrix}1 \\ j \\ 0\end{matrix} ] , \frac{1}{\sqrt{3}} [ \begin{matrix}1 \\ − j \\ 0\end{matrix} ] \}$$

$$Rank = 2 : \{ \frac{1}{\sqrt{6}} [ \begin{matrix}1 & 1 \\ 1 & − 1 \\ 0 & 0\end{matrix} ] , \frac{1}{\sqrt{6}} [ \begin{matrix}1 & 1 \\ j & − j \\ 0 & 0\end{matrix} ] , \frac{1}{\sqrt{3}} [ \begin{matrix}1 & 0 \\ 1 & 0 \\ 0 & 1\end{matrix} ] , \frac{1}{\sqrt{3}} [ \begin{matrix}1 & 0 \\ − 1 & 0 \\ 0 & 1\end{matrix} ] , \frac{1}{\sqrt{3}} [ \begin{matrix}1 & 0 \\ j & 0 \\ 0 & 1\end{matrix} ] , \frac{1}{\sqrt{3}} [ \begin{matrix}1 & 0 \\ − j & 0 \\ 0 & 1\end{matrix} ] \}$$

$$Rank = 3 : \{ \frac{1}{\sqrt{5}} [ \begin{matrix}1 & 1 & 0 \\ 1 & − 1 & 0 \\ 0 & 0 & 1\end{matrix} ] , \frac{1}{\sqrt{5}} [ \begin{matrix}1 & 1 & 0 \\ j & − j & 0 \\ 0 & 0 & 1\end{matrix} ] \} ,$$

It should be noted that, if the first SRS resource group and the second SRS resource group each includes only one SRS resource, that is, the first SRS resource and the second SRS resource, respectively, the network device does not need to transmit the SRI information, and the terminal device does not need to receive the SRI information. If the first SRS resource group or the second SRS resource group includes a plurality of SRS resources, the terminal device needs to receive the SRI information configured by the network device, and determine the first SRS resource and the second SRS resource from the first SRS resource group and the second SRS resource group, respectively, based on the SRI information.

If the correspondence between the SRS resources adopts the first correspondence method described above, the SRI information indicates an index value n−1, which corresponds to the n-th SRS resource in the first SRS resource group and the n-th SRS resource in the second SRS resource group. That is, the SRI information indicates only one index value, and the terminal device determines the first SRS resource from the first SRS resource group and the second SRS resource from the second SRS resource group, respectively, based on the index value.

If the correspondence between the SRS resources adopts the second correspondence method described above, the SRI information may indicate an SRS resource pair from among the SRS resource pairs configured by the network device. Each SRS resource pair configured by the network device includes an SRS resource in the first SRS resource group and an SRS resource in the second SRS resource group, respectively.

At operation 1.5, the terminal device performs precoding on uplink data based on the precoding scheme, and transmits the precoded data on the antenna ports corresponding to the first SRS resource and the second SRS resource.

Illustratively, the terminal device performs precoding on the uplink data using a precoding matrix for the three antenna ports indicated by the TPMI, and transmits the precoded uplink data on the three antenna ports composed of the two antenna ports corresponding to the first SRS resource and the single antenna port corresponding to the second SRS resource.

It will be appreciated that in the first embodiment, one TPMI may be used for determining the precoding scheme on the three ports. Also, the first embodiment requires to be implemented in conjunction with a codebook for the three ports.

### Second Embodiment

The method provided by the second embodiment may include operations 2.1 to 2.4.

At operation 2.1, a network device transmits configuration information to a terminal device. The terminal device receives the configuration information. The configuration information is used for configuring a first SRS resource group and a second SRS resource group.

The first SRS resource group includes one or more SRS resources for two antenna ports, and the second SRS resource group includes one or more SRS resources for a single antenna port.

The first SRS resource group and the second SRS resource group are two different SRS resource sets. The SRS resources in the two SRS resource sets may be the same or different.

In order to ensure that the uplink channel information measured from the two SRS resource groups may be used to schedule the same PUSCH, at least one of the following parameter configurations for the two SRS resource groups may be the same: a frequency domain resource, a slot configuration, an OFDM symbol configuration, a frequency domain hopping configuration, a sequence hopping configuration, a cyclic shift hopping configuration, a comb offset hopping configuration, or a power control parameter.

At operation 2.1, the terminal device transmits SRSs on the first SRS resource group and the second SRS resource group. Correspondingly, the network device receives the SRSs transmitted by the terminal device on the first SRS resource group and the second SRS resource group.

At operation 2.2, the network device determines TPMI information based on the received SRSs, and transmits indication information to the terminal device. The indication information includes the TPMI information.

The TPMI information includes a first TPMI and a second TPMI. The network device may determine the first TPMI based on channel information measured from the first SRS resource, and determine the second TPMI based on channel information measured from the second SRS resource. The first TPMI is used for determining the precoding scheme on the antenna ports corresponding to the first SRS resource, and the second TPMI is used for determining the precoding scheme on the antenna port corresponding to the second SRS resource.

If the first SRS resource group and the second SRS resource group each includes only one SRS resource, they are the first SRS resource and the second SRS resource, respectively. If the first SRS resource group or the second SRS resource group includes a plurality of SRS resources, the network device may further determine SRI information based on the received SRSs, and indicate the first SRS resource and the second SRS resource by the SRI information. The network device may select an optimal SRS resource based on the received signal strength of different SRS resources in the SRS resource group, and use an index corresponding to the SRS resource as SRI information, so the SRI information may include two indexes (SRIs) corresponding to the first SRS resource group and the second SRS resource group, respectively.

At operation 2.3, the terminal device receives TPMI information indicated by the network device, and determines a precoding scheme on antenna ports corresponding to a first SRS resource and a second SRS resource based on the TPMI information.

The first SRS resource group includes the first SRS resource, and the second SRS resource group includes the second SRS resource.

The first SRS resource and the second SRS resource may be determined based on SRI information from the network device.

If the first SRS resource group and the second SRS resource group each includes only one SRS resource, that is, the first SRS resource and the second SRS resource, the network device does not need to transmit the SRI information, and the terminal device does not need to receive the SRI information. If the first SRS resource group or the second SRS resource group includes a plurality of SRS resources, the terminal device may receive the SRI information configured by the network device, and determine the first SRS resource and the second SRS resource from the first SRS resource group and the second SRS resource group, respectively, based on the SRI information.

In an implementation, the SRI information includes a first SRI for determining the first SRS resource from the first SRS resource group and a second SRI for determining the second SRS resource from the second SRS resource group. That is, the first SRI is associated with the first SRS resource group, and the second SRI is associated with the second SRS resource group.

It should be noted that, the first SRI and the second SRI may not necessarily exist at the same time. When the first SRS resource group includes a plurality of SRS resources, the SRI information may include the first SRI. When the second SRS resource group includes a plurality of SRS resources, the SRI information may include the second SRI.

As described above, the TPMI information includes a first TPMI used for determining a precoding scheme on antenna ports corresponding to the first SRS resource and a second TPMI used for determining a precoding scheme on an antenna port corresponding to the second SRS resource. That is, the first TPMI is associated with the first SRS resource group, and the second TPMI is associated with the second SRS resource group.

The first TPMI indicates whether the antenna ports corresponding to the first SRS resource are used for data transmission, or indicates a precoding matrix for the two antenna ports.

In an implementation, the first TPMI includes 2-bit information. The two bits indicate whether the two antenna ports corresponding to the first SRS resource are used for data transmission, respectively. For example, the first bit indicates whether the first antenna port is used for data (PUSCH) transmission, and the second bit indicates whether the second antenna port is used for data (PUSCH) transmission. If both bits are 0, it may indicate that neither of the two antenna ports corresponding to the first SRS resource is used for data transmission.

In another implementation, the first TPMI includes 2-bit information indicating a precoding matrix for the two antenna ports. Further, the 2-bit information may indicate that neither of the two antenna ports corresponding to the first SRS resource is used for data transmission, that is, the precoding matrix is

$$\frac{1}{\sqrt{3}} [ \begin{matrix}0 \\ 0\end{matrix} ] .$$

For example, for a non-coherent terminal, the two bits may indicate one of: 00 indicates the precoding matrix

$$\frac{1}{\sqrt{3}} [ \begin{matrix}1 \\ 0\end{matrix} ] ;$$

01 indicates the precoding matrix

$$\frac{1}{\sqrt{3}} [ \begin{matrix}0 \\ 1\end{matrix} ] ;$$

10 indicates the precoding matrix

$$\frac{1}{\sqrt{3}} [ \begin{matrix}1 & 0 \\ 0 & 1\end{matrix} ] ;$$

and 11 indicates that the two antenna ports are not used for data transmission.

It should be noted that a value and indication content of the 2-bit information contained in the first TPMI are merely examples, and an actual indication value and indication content may be exchanged. For example, 00 may indicate that the two antenna ports are not used for data transmission. In addition,

$$\frac{1}{\sqrt{3}}$$

Here is a power normalization coefficient, which is used to ensure the power normalization when three antenna ports are used at the same time.

In another implementation, the first TPMI may include more than 2 bits of information (e.g., 4 bits) for indicating a precoding matrix for the two antenna ports. The precoding matrix may be used for a fully coherent terminal. For example, the information may indicate one of:

$$\frac{1}{\sqrt{3}} [ \begin{matrix}1 \\ 1\end{matrix} ] , \frac{1}{\sqrt{3}} [ \begin{matrix}1 \\ − 1\end{matrix} ] , \frac{1}{\sqrt{3}} [ \begin{matrix}1 \\ j\end{matrix} ] , \frac{1}{\sqrt{3}} [ \begin{matrix}1 \\ − j\end{matrix} ] , \frac{1}{\sqrt{3}} [ \begin{matrix}1 \\ 0\end{matrix} ] , \frac{1}{\sqrt{3}} [ \begin{matrix}0 \\ 1\end{matrix} ] , \frac{1}{\sqrt{6}} [ \begin{matrix}1 & 1 \\ 1 & − 1\end{matrix} ] , \frac{1}{\sqrt{6}} [ \begin{matrix}1 & 1 \\ j & − j\end{matrix} ] , \frac{1}{\sqrt{3}} [ \begin{matrix}1 & 0 \\ 0 & 1\end{matrix} ] ;$$

or the two antenna ports are not used for data transmission. Herein,

$$\frac{1}{\sqrt{3}} and \frac{1}{\sqrt{6}}$$

are power normalization coefficients, which are used to ensure power normalization when three antenna ports are used at the same time.

Illustratively, the second TPMI indicates whether the antenna port corresponding to the second SRS resource is used for data transmission. That is, the second TPMI may be only 1 bit for indicating whether the antenna port is used for data transmission. For example, 0 may indicate that the antenna port is not used for data transmission, and 1 may indicate that the antenna port is used for data transmission.

Further, each of the first TPMI and the second TPMI indicates a number of transmission layers on the antenna ports corresponding to the first SRS resource and the second SRS resource respectively.

Optionally, the number of transmission layers may be determined based on information indicated by the TPMI. For example, if the first TPMI indicates whether two antenna ports corresponding to the first SRS resource are used for data transmission, the number of transmission layers on the antenna ports corresponding to the first SRS resource may be the number of antenna ports used for data transmission (0, 1, or 2). If the first TPMI indicates a precoding matrix for the two antenna ports, the number of transmission layers on the antenna ports corresponding to the first SRS resource is the number of columns in the precoding matrix. For the second TPMI, if the second TPMI indicates that the antenna port corresponding to the second SRS resource is used for data transmission, the number of transmission layers corresponding to the second SRS resource is 1, otherwise, the number of transmission layers corresponding to the second SRS resource is 0.

Optionally, the total number of transmission layers for the uplink data (i.e., a rank value in the uplink) is equal to the sum of the number of transmission layers indicated by the first TPMI and the number of transmission layers indicated by the second TPMI.

It should be noted that the first TPMI and the second TPMI are not allowed to both indicate that the corresponding antenna ports are not used for data transmission, that is, the number of transmission layers indicated by the first TPMI and the number of transmission layers indicated by the second TPMI are not allowed to both be 0. Otherwise, no antenna port would be available for transmitting the scheduled uplink data.

In an implementation, the terminal device may report first information and second information to the network device via a UE capability. The first information indicates whether the two antenna ports corresponding to the first SRS resource are capable of supporting full power transmission. The second information indicates whether the antenna port corresponding to the second SRS resource is capable of supporting full power transmission.

For example, the first information may include 2 bits indicating whether the first antenna port and the second antenna port, respectively, are capable of supporting full power transmission, so that the network device may schedule the respective antenna ports to achieve greater transmission power. For example, 10 may indicate that the first antenna port supports full power transmission; and 00 may indicate that neither of the two antenna ports supports full power transmission, but both antenna ports together support full power transmission when transmitting simultaneously.

For example, the second information may include 1 bit indicating whether the single antenna port corresponding to the second SRS resource is capable of supporting full power transmission. For example, 0 may indicate that full power transmission is not supported, and 1 may indicate that full power transmission is supported.

At operation 2.4, the terminal device performs precoding on uplink data based on the precoding scheme, and transmits the precoded data on the antenna ports corresponding to the first SRS resource and the second SRS resource.

Illustratively, respective transmission layers in the uplink data may be mapped to different antenna ports. That is, up to three transmission layers may be transmitted in the uplink, each transmission layer is mapped to a respective antenna port, and the unmapped antenna port may not be used for uplink transmission.

In an implementation, when the antenna ports corresponding to the first SRS resource and the antenna port corresponding to the second SRS resource are all used for transmitting uplink data, the respective transmission layers in the uplink data may be mapped to the antenna port corresponding to the first SRS resource first, and then mapped to the antenna port corresponding to the second SRS resource.

For example, when the number of transmission layers is 2 and the antenna ports corresponding to the two SRS resources each transmits a respective transmission layer, the first transmission layer is mapped to the antenna port corresponding to the first SRS resource first, and then the second transmission layer is mapped to the antenna port corresponding to the second SRS resource. When the number of transmission layers is 3, the first two transmission layers are mapped to the antenna ports corresponding to the first SRS resource, and then the third transmission layer is mapped to the antenna port corresponding to the second SRS resource.

Since the first SRS resource and the second SRS resource correspond to different SRIs or TPMIs, the method may also be implemented as follows. When the SRI information indicates two SRIs or the TPMI information indicates two TPMIs, the transmission layer in the uplink data may first correspond to the first SRI (the first SRI is used for the transmission layer), and then correspond to the second SRI (the second SRI is used for the transmission layer); or the transmission layer in the uplink data may first correspond to the first TPMI (the first TPMI is used for the transmission layer), and then correspond to the second TPMI (the second TPMI is used for the corresponding transmission layer). For example, when the number of transmission layers is 3, the first TPMI is used for the first two transmission layers, and the second TPMI is used for the third transmission layer.

In another implementation, when the antenna ports corresponding to the first SRS resource and the antenna port corresponding to the second SRS resource are all used for transmitting uplink data, the respective transmission layers in the uplink data may be mapped to the antenna port corresponding to the second SRS resource first, and then mapped to the antenna port corresponding to the first SRS resource.

For example, when the number of transmission layers is 3, the first transmission layer is mapped to the antenna port corresponding to the second SRS resource first, and the latter two transmission layers are mapped to the antenna ports corresponding to the first SRS resource.

Since the first SRS resource and the second SRS resource correspond to different SRIs or TPMIs, the method may also be implemented as follows. When the SRI information indicates two SRIs or the TPMI information indicates two TPMIs, the transmission layer in the uplink data may first correspond to the second SRI (the second SRI is used for the transmission layer), and then correspond to the first SRI (the first SRI is used for the transmission layer); or the transmission layer in the uplink data may first correspond to the second TPMI (the second TPMI is used for the transmission layer) and then correspond to the first TPMI (the first TPMI is used for the corresponding transmission layer). For example, when the number of transmission layers is 3, the first TPMI may be used for the latter two transmission layers, and the second TPMI may be used for the first transmission layer.

It will be appreciated that in the second embodiment, the first TPMI for the two ports and the second TPMI for the single port may be indicated or used, respectively. Therefore, the second embodiment can be implemented based on the codebook for the two ports in the related art.

Method embodiments of the disclosure are described in detail above, and device embodiments of the disclosure will be described in detail below. It should be understood that the description of the method embodiments corresponds to the description of the device embodiments, and thus, the portions not described in detail can be referred to the foregoing method embodiments.

FIG. 4 is a schematic structural diagram of a terminal device 400 according to an embodiment of the disclosure. The terminal device 400 may include a first receiving unit 410, a first transmitting unit 420, and a second receiving unit 430.

The first receiving unit 410 is configured to receive configuration information from a network device, and the configuration information is used for configuring a first SRS resource group and a second SRS resource group. The first SRS resource group includes one or more SRS resources for two antenna ports, and the second SRS resource group includes one or more SRS resources for a single antenna port.

The first transmitting unit 420 is configured to transmit SRSs on the first SRS resource group and the second SRS resource group.

The second receiving unit 430 is configured to receive indication information from the network device. The indication information includes TPMI information, the TPMI information is used for determining a precoding scheme on antenna ports corresponding to a first SRS resource and a second SRS resource, the first SRS resource group includes the first SRS resource, and the second SRS resource group includes the second SRS resource.

In some embodiments, the first SRS resource group and the second SRS resource group are two SRS resource groups in a same SRS resource set, or the first SRS resource group and the second SRS resource group are two different SRS resource sets.

In some embodiments, one or more of following configurations for an SRS resource in the first SRS resource group and for an SRS resource in the second SRS resource group are the same: a frequency domain resource, a slot configuration, an OFDM symbol configuration, a frequency domain hopping configuration, a sequence hopping configuration, a cyclic shift hopping configuration, a comb offset hopping configuration, or a power control parameter.

In some embodiments, each SRS resource in the first SRS resource group corresponds to at least one SRS resource in the second SRS resource group.

In some embodiments, the first SRS resource group and the second SRS resource group include a same number of SRS resources, and each of the SRS resources in the first SRS resource group corresponds to a respective one of the SRS resources in the second SRS resource group.

In some embodiments, two corresponding SRS resources satisfy one or more of: occupying a same physical resource; using a same transmission beam; or using a same transmission power.

In some embodiments, the TPMI information indicates a precoding matrix for three antenna ports, and the three antenna ports are composed of the two antenna ports corresponding to the first SRS resource and the single antenna port corresponding to the second SRS resource.

In some embodiments, the TPMI information includes a first TPMI and a second TPMI, the first TPMI is used for determining the precoding scheme on the antenna ports corresponding to the first SRS resource, and the second TPMI is used for determining the precoding scheme on the antenna port corresponding to the second SRS resource.

In some embodiments, the first TPMI indicates whether the antenna ports corresponding to the first SRS resource are used for data transmission, and/or the first TPMI indicates a precoding matrix for the two antenna ports.

In some embodiments, the first TPMI includes 2-bit information, and two bits in the 2-bit information indicate whether the two antenna ports corresponding to the first SRS resource are used for data transmission, respectively, or the 2-bit information indicates one of: the precoding matrix is

$$\frac{1}{\sqrt{3}} [ \begin{matrix}1 \\ 0\end{matrix} ] ;$$

the precoding matrix is

$$\frac{1}{\sqrt{3}} [ \begin{matrix}0 \\ 1\end{matrix} ] ;$$

the precoding matrix is

$$\frac{1}{\sqrt{3}} [ \begin{matrix}1 & 0 \\ 0 & 1\end{matrix} ] ;$$

or the two antenna ports are not used for data transmission.

In some embodiments, the second TPMI indicates whether the antenna port corresponding to the second SRS resource is used for data transmission.

In some embodiments, each of the first TPMI and the second TPMI further indicates a number of transmission layers on the antenna ports corresponding to the first SRS resource and the second SRS resource respectively.

In some embodiments, a total number of transmission layers for uplink data is equal to a sum of the number of transmission layers indicated by the first TPMI and the number of transmission layers indicated by the second TPMI.

In some embodiments, the first TPMI and the second TPMI are not allowed to both indicate that the corresponding antenna ports are not used for data transmission, or a number of transmission layers indicated by the first TPMI and a number of transmission layers indicated by the second TPMI are not allowed to both be 0.

In some embodiments, the terminal device is further configured to: transmit first information and second information to the network device. The first information indicates whether the two antenna ports corresponding to the first SRS resource are capable of supporting full power transmission, and the second information indicates whether the single antenna port corresponding to the second SRS resource is capable of supporting full power transmission.

In some embodiments, the terminal device is further configured to: receive SRI information from the network device. The SRI information is used for determining the first SRS resource and the second SRS resource from the first SRS resource group and the second SRS resource group, respectively.

In some embodiments, when the SRI information indicates an index n−1, the first SRS resource corresponds to the n-th SRS resource in the first SRS resource group, and the second SRS resource corresponds to the n-th SRS resource in the second SRS resource group.

In some embodiments, the SRI information includes a first SRI used for determining the first SRS resource from the first SRS resource group and a second SRI used for determining the second SRS resource from the second SRS resource group.

In some embodiments, the terminal device is further configured to: perform precoding on the uplink data based on the precoding scheme. The terminal device transmits the precoded data on the antenna ports corresponding to the first SRS resource and the second SRS resource.

In some embodiments, respective transmission layers in the uplink data are mapped to different antenna ports among the antenna ports corresponding to the first SRS resource and the second SRS resource.

In some embodiments, the respective transmission layers in the uplink data are mapped to the antenna port corresponding to the first SRS resource first, and then mapped to the antenna port corresponding to the second SRS resource, or the respective transmission layers in the uplink data are mapped to the antenna port corresponding to the second SRS resource first, and then mapped to the antenna port corresponding to the first SRS resource.

In an alternative embodiment, the first receiving unit 410, the first transmitting unit 420, or the second receiving unit 430 may be a transceiver 630. The terminal device 400 may further include a processor 610 and a memory 620, as specifically shown in FIG. 6.

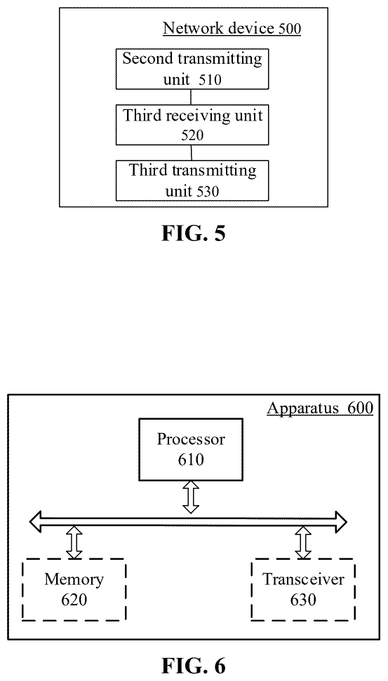

FIG. 5 is a schematic structural diagram of a network device 500 according to an embodiment of the disclosure. The network device 500 includes a second transmitting unit 510, a third receiving unit 520, and a third transmitting unit 530.

The second transmitting unit 510 is configured to transmit configuration information to a terminal device. The configuration information is used for configuring a first SRS resource group and a second SRS resource group, the first SRS resource group includes one or more SRS resources for two antenna ports, and the second SRS resource group includes one or more SRS resources for a single antenna port.

The third receiving unit 520 is configured to receive SRSs transmitted by the terminal device on the first SRS resource group and the second SRS resource group.

The third transmitting unit 530 is configured to transmit indication information to the terminal device. The indication information includes TPMI information for determining a precoding scheme on antenna ports corresponding to a first SRS resource and a second SRS resource. The first SRS resource group includes the first SRS resource, and the second SRS resource group includes the second SRS resource.

In some embodiments, the first SRS resource group and the second SRS resource group are two SRS resource groups in a same SRS resource set, or the first SRS resource group and the second SRS resource group are two different SRS resource sets.

In some embodiments, one or more of following configurations for an SRS resource in the first SRS resource group and for an SRS resource in the second SRS resource group are the same: a frequency domain resource, a slot configuration, an OFDM symbol configuration, a frequency domain hopping configuration, a sequence hopping configuration, a cyclic shift hopping configuration, a comb offset hopping configuration, or a power control parameter.

In some embodiments, each SRS resource in the first SRS resource group corresponds to at least one SRS resource in the second SRS resource group.

In some embodiments, the first SRS resource group and the second SRS resource group include a same number of SRS resources, and each of the SRS resources in the first SRS resource group corresponds to a respective one of the SRS resources in the second SRS resource group.

In some embodiments, two corresponding SRS resources satisfy one or more of: occupying a same physical resource; using a same transmission beam; or using a same transmission power.

In some embodiments, the TPMI information indicates a precoding matrix for three antenna ports, and the three antenna ports are composed of the two antenna ports corresponding to the first SRS resource and the single antenna port corresponding to the second SRS resource.

In some embodiments, the TPMI information includes a first TPMI and a second TPMI, the first TPMI is used for determining the precoding scheme on the antenna ports corresponding to the first SRS resource, and the second TPMI is used for determining the precoding scheme on the antenna port corresponding to the second SRS resource.

In some embodiments, the first TPMI indicates whether the antenna ports corresponding to the first SRS resource are used for data transmission, and/or the first TPMI indicates a precoding matrix for the two antenna ports.

In some embodiments, the first TPMI includes 2-bit information, and two bits in the 2-bit information indicate whether the two antenna ports corresponding to the first SRS resource are used for data transmission, respectively, or the 2-bit information indicates one of: the precoding matrix is

$$\frac{1}{\sqrt{3}} [ \begin{matrix}1 \\ 0\end{matrix} ] ;$$

the precoding matrix is

$$\frac{1}{\sqrt{3}} [ \begin{matrix}0 \\ 1\end{matrix} ] ;$$

the precoding matrix is

$$\frac{1}{\sqrt{3}} [ \begin{matrix}1 & 0 \\ 0 & 1\end{matrix} ] ;$$

or the two antenna ports are not used for data transmission.

In some embodiments, the second TPMI indicates whether the antenna port corresponding to the second SRS resource is used for data transmission.

In some embodiments, each of the first TPMI and the second TPMI further indicates a number of transmission layers on the antenna ports corresponding to the first SRS resource and the second SRS resource respectively.

In some embodiments, a total number of transmission layers for uplink data is equal to a sum of the number of transmission layers indicated by the first TPMI and the number of transmission layers indicated by the second TPMI.

In some embodiments, the first TPMI and the second TPMI are not allowed to both indicate that the corresponding antenna ports are not used for data transmission, or a number of transmission layers indicated by the first TPMI and a number of transmission layers indicated by the second TPMI are not allowed to both be 0.

In some embodiments, the network device is further configured to: receive first information and second information from the terminal device. The first information indicates whether the two antenna ports corresponding to the first SRS resource are capable of supporting full power transmission, and the second information indicates whether the single antenna port corresponding to the second SRS resource is capable of supporting full power transmission.

In some embodiments, the network device is further configured to: transmit SRI information to the terminal device. The SRI information is used for determining the first SRS resource and the second SRS resource from the first SRS resource group and the second SRS resource group, respectively.

In some embodiments, when the SRI information indicates an index n−1, the first SRS resource corresponds to an n-th SRS resource in the first SRS resource group, and the second SRS resource corresponds to an n-th SRS resource in the second SRS resource group.

In some embodiments, the SRI information includes a first SRI used for determining the first SRS resource from the first SRS resource group and a second SRI used for determining the second SRS resource from the second SRS resource group.

In some embodiments, the network device is further configured to receive uplink data transmitted by the terminal device after being precoded using the precoding manner.

In an alternative embodiment, the second transmitting unit 510, the third receiving unit 520, or the third transmitting unit 530 may be a transceiver 630. The network device 500 may further include a processor 610 and a memory 620, as specifically shown in FIG. 6.

FIG. 6 is a schematic structural diagram of an apparatus for communication according to an embodiment of the disclosure. The dashed line in FIG. 6 indicates that the unit or module is optional. The apparatus 600 may be used to implement the methods described in the method embodiments above. The apparatus 600 may be a chip, a terminal device, or a network device.

The apparatus 600 may include one or more processors 610. The processor 610 may support the apparatus 600 to implement the methods described in the previous method embodiments. The processor 610 may be a general-purpose processor or a special-purpose processor. For example, the processor may be a central processing unit (CPU). Alternatively, the processor may also be another general-purpose processor, a digital signal processor (DSP), an application specific integrated circuit (ASIC), a field programmable gate array (FPGA) or other programmable logic devices, a discrete gate or transistor logic device, a discrete hardware component, or the like. The general-purpose processor may be a microprocessor or the processor may be any conventional processor or the like.

The apparatus 600 may further include one or more memories 620. The memory 620 has stored thereon a program that is executable by the processor 610 to enable the processor 610 to perform the methods described in the above method embodiments. The memory 620 may be independent of the processor 610 or may be integrated into the processor 610.

The apparatus 600 may further include a transceiver 630. The processor 610 may communicate with other devices or chips through the transceiver 630. For example, the processor 610 may transmit and receive data with other devices or chips through the transceiver 630.

An embodiment of the disclosure further provides a terminal device, including a processor and a memory for storing one or more computer programs. The processor is configured to call the computer programs in the memory to cause the terminal device to perform part or all of the operations in the method executed by the terminal device in each embodiment of the disclosure.

An embodiment of the disclosure further provides a network device, including a processor and a memory for storing one or more computer programs. The processor is configured to call the computer programs in the memory to cause the network device to perform part or all of the operations in the method executed by the network device in each embodiment of the disclosure.

An embodiment of the disclosure further provides a communication system, including the above-described terminal device and/or network device. In another possible design, the system may further include other devices that interact with the terminal device or the network device in the solution provided by the embodiments of the disclosure.

An embodiment of the disclosure further provides a computer-readable storage medium for storing a program. The computer-readable storage medium may be applied to the terminal device or the network device provided by the embodiments of the disclosure, and the program enables a computer to execute the method executed by the terminal device or the network device in each embodiment of the disclosure.

An embodiment of the disclosure further provides a computer program product. The computer program product includes a program. The computer program product may be applied to the terminal device or the network device provided by the embodiments of the disclosure, and the program enables a computer to execute the method executed by the terminal device or the network device in each embodiment of the disclosure.

An embodiment of the disclosure further provides a computer program. The computer program may be applied to the terminal device or the network device provided by the embodiments of the disclosure, and the computer program enables a computer to execute the method executed by the terminal device or the network device in each embodiment of the disclosure.

An embodiment of the disclosure further provides a chip including a memory and a processor, and the processor may call a computer program from the memory and run the computer program to implement part or all of the operations described in the methods described above.

According to the disclosure, uplink channel information measured in the first SRS resource (an SRS resource for two antenna ports) and the second SRS resource (an SRS resource for a single antenna port) may be used to schedule the same uplink channel or signal, thereby supporting uplink transmission based on three antenna ports. For example, an equivalent SRS resource for the three antenna ports may be formed by combining an SRS resource for the two antenna ports and an SRS resource for the single antenna port. Compared with the two antenna ports, supporting the uplink transmission with the three antenna ports can significantly improve uplink spectral efficiency. Furthermore, the SRS resource for the three antenna ports may be formed in the disclosure based on the SRS resource for the two antenna ports and the SRS resource for the single antenna port in the related art. Therefore, the disclosure can implement three-port transmission with lower standardization complexity and without introducing a new SRS resource for the three antenna ports.

It is to be understood that the terms “system” and “network” may be used interchangeably in the disclosure. In addition, the terms used in the disclosure is for explanation of specific embodiments of the disclosure only, and is not intended to limit the disclosure. The terms “first”, “second”, “third”, and “fourth” etc. in the specification, claims and the accompanying drawings of the disclosure are used to distinguish different objects, and are not intended to describe a specific order. Furthermore, the terms “comprising” and “having” and any variations thereof are intended to cover non-exclusive inclusions.

The “indication” mentioned in the embodiments of the disclosure may be a direct indication, an indirect indication, or represents an association relationship. For example, A indicates B, which may mean that A directly indicates B, for example, B may be obtained through A; or mean that A indicates B indirectly, for example, A indicates C, and B may be obtained through C; or mean that there is an association relationship between A and B.

In the embodiments of the disclosure, “B corresponding to A” means that B is associated with A, and B may be determined from A. However, it should also be understood that determining B from A does not mean that B is determined from A alone, and B may also be determined from A and/or other information.

In the embodiments of the disclosure, the term “correspondence” may indicate that there is a direct correspondence or indirect correspondence between two items, may indicate that there is an association relationship between the two items, or may indicate a relationship such as indicating and being indicated, configuring and being configured, or the like.

In the embodiments of the disclosure, “predefined” or “preconfigured” may be implemented by storing corresponding codes or tables in advance in devices (including, for example, the terminal device and the network device) or by other ways that may be used to indicate relevant information, and the specific implementation thereof is not limited herein. For example, the predefinition may refer to what is defined in a protocol.

In the embodiments of the disclosure, the “protocol” may refer to a standard protocol in the communication field, and may include, for example, an LTE protocol, an NR protocol, and related protocols applied to future communication systems, and the disclosure is not limited thereto.

The term “and/or” in the embodiments of the disclosure is only used to describe an association relationship between associated objects, and represents that three relationships may exist. For example, A and/or B may represent the three conditions: independent existence of A, existence of both A and B and independent existence of B. In addition, the character “/” in the disclosure usually represents that previous and next associated objects form an “or” relationship.

In the embodiments of the disclosure, the “comprising/including” may refer to directly including or indirectly including. Optionally, the reference to “comprising” in the embodiments of the disclosure may be replaced with “indicating” or “for determining”. For example, “A including B” may be replaced with “A indicating B”, or “A being used for determining B”.

In various embodiments of the disclosure, an order of the serial numbers of the above-mentioned processes does not imply an execution order, and the execution order of various processes are determined based on their functions and inherent logics, and should not constitute any limitation on the implementation process of the embodiments of the disclosure.

In the several embodiments provided in the disclosure, it is to be understood that the disclosed systems, devices and methods may be implemented in other ways. For example, the device embodiments described above are only schematic, and for example, a division of the units is only a logic function division, and other division manners may be adopted during a practical implementation. For example, multiple units or components may be combined or integrated into another system, or some characteristics may be neglected or not executed. In addition, the displayed or discussed mutual coupling or direct coupling or communication connection may be an indirect coupling or communication connection implemented through some interfaces, devices or units, and may be implemented in electronic, mechanical, or other forms.

The units described as separate components may or may not be physically separated, and the components displayed as units may or may not be physical units, and may be located in one place or may be distributed over multiple network units. Some or all of the units may be selected according to actual needs to achieve the objectives of the solutions in the embodiments of the disclosure.

In addition, functional units in various embodiments of the disclosure may be integrated into one processing unit, or each of the units may exist as a separate physical unit, or two or more units may be integrated into one unit.

The aforementioned embodiments may be implemented in whole or in part by software, hardware, firmware or any combination thereof. When implemented in software, the aforementioned embodiments may be implemented in whole or in part in the form of a computer program product. The computer program product includes one or more computer instructions. When the computer program instructions are loaded and executed on a computer, flows or functions described in the embodiments of the present disclosure may be generated in whole or in part. The computer may be a general-purpose computer, a dedicated computer, a computer network, or other programmable devices. The computer instructions may be stored in a computer-readable storage medium or transmitted from one computer-readable storage medium to another computer-readable storage medium. For example, the computer instructions may be transmitted from one web site, computer, server, or data center to another web site, computer, server, or data center in a wired (e.g., a coaxial cable, an optical fiber, a digital subscriber line (DSL)) manner or a wireless (e.g., an infrared, a wireless, a microwave, etc.) manner. The computer-readable storage medium may be any available medium that a computer may access or may be a data storage device such as a server, a data center, or the like that is integrated with one or more available media. The available medium may be a magnetic medium (e.g., a floppy disk, a hard disk, a magnetic tape), an optical medium (e.g., a digital video disc (DVD)), or a semiconductor medium (e.g., a solid state disk (SSD)), etc.

The above description pertains only to specific implementations of the disclosure, but the scope of protection of the disclosure is not limited thereto. Any variation or replacement readily figured out by a person skilled in the art within the technical scope disclosed in the disclosure shall fall within the scope of protection of the disclosure. Therefore, the scope of protection of the disclosure is defined by the scope of protection of the claims.

1. A wireless communication method, comprising:
receiving, by a terminal device, configuration information from a network device, wherein the configuration information is used for configuring a first sounding reference signal (SRS) resource group and a second SRS resource group, the first SRS resource group comprises one or more SRS resources for two antenna ports, and the second SRS resource group comprises one or more SRS resources for a single antenna port;
transmitting, by the terminal device, SRSs on the first SRS resource group and the second SRS resource group; and
receiving, by the terminal device, indication information from the network device, wherein the indication information comprises transmit precoding matrix indicator (TPMI) information, the TPMI information is used for determining a precoding scheme on antenna ports corresponding to a first SRS resource and a second SRS resource, the first SRS resource group comprises the first SRS resource, and the second SRS resource group comprises the second SRS resource.

2. The method of claim 1, wherein
the first SRS resource group and the second SRS resource group are two SRS resource groups in a same SRS resource set, or the first SRS resource group and the second SRS resource group are two different SRS resource sets, and/or
one or more of following configurations for an SRS resource in the first SRS resource group and for an SRS resource in the second SRS resource group are the same: a frequency domain resource, a slot configuration, an orthogonal frequency division multiplexing (OFDM) symbol configuration, a frequency domain hopping configuration, a sequence hopping configuration, a cyclic shift hopping configuration, a comb offset hopping configuration, or a power control parameter.

3. The method of claim 1, wherein
the TPMI information comprises a first TPMI and a second TPMI, the first TPMI is used for determining the precoding scheme on the antenna ports corresponding to the first SRS resource, and the second TPMI is used for determining the precoding scheme on the antenna port corresponding to the second SRS resource,
the first TPMI indicates whether the antenna ports corresponding to the first SRS resource are used for data transmission, and/or the first TPMI indicates a precoding matrix for the two antenna ports, and
the second TPMI indicates whether the antenna port corresponding to the second SRS resource is used for data transmission.

4. The method of claim 3, wherein the first TPMI comprises 2-bit information, and two bits in the 2-bit information indicate whether the two antenna ports corresponding to the first SRS resource are used for data transmission, respectively, or the 2-bit information indicates one of:
the precoding matrix is
$$\frac{1}{\sqrt{3}} [ \begin{matrix}1 \\ 0\end{matrix} ] ;$$
the precoding matrix is
$$\frac{1}{\sqrt{3}} [ \begin{matrix}0 \\ 1\end{matrix} ] ;$$
the precoding matrix is
$$\frac{1}{\sqrt{3}} [ \begin{matrix}1 & 0 \\ 0 & 1\end{matrix} ] ;$$
or
the two antenna ports are not used for data transmission.

5. The method of claim 3, wherein the first TPMI and the second TPMI are not allowed to both indicate that the corresponding antenna ports are not used for data transmission, or a number of transmission layers indicated by the first TPMI and a number of transmission layers indicated by the second TPMI are not allowed to both be 0.

6. The method of claim 1, further comprising:
receiving, by the terminal device, sounding reference signal resource indicator (SRI) information from the network device, wherein
the SRI information is used for determining the first SRS resource and the second SRS resource from the first SRS resource group and the second SRS resource group, respectively,
when the SRI information indicates an index n−1, the first SRS resource corresponds to an n-th SRS resource in the first SRS resource group, and the second SRS resource corresponds to an n-th SRS resource in the second SRS resource group,
the SRI information comprises a first SRI for determining the first SRS resource from the first SRS resource group and a second SRI for determining the second SRS resource from the second SRS resource group.

7. A terminal device, comprising:
a processor; and
a memory for storing a program executable by the processor;
wherein the processor is configured to execute the program to control the terminal device to:
receive configuration information from a network device, wherein the configuration information is used for configuring a first sounding reference signal (SRS) resource group and a second SRS resource group, the first SRS resource group comprises one or more SRS resources for two antenna ports, and the second SRS resource group comprises one or more SRS resources for a single antenna port;
transmit SRSs on the first SRS resource group and the second SRS resource group; and
receive indication information from the network device, wherein the indication information comprises transmit precoding matrix indicator (TPMI) information, the TPMI information is used for determining a precoding scheme on antenna ports corresponding to a first SRS resource and a second SRS resource, the first SRS resource group comprises the first SRS resource, and the second SRS resource group comprises the second SRS resource.

8. The terminal device of claim 7, wherein
each SRS resource in the first SRS resource group corresponds to at least one SRS resource in the second SRS resource group,
the first SRS resource group and the second SRS resource group comprise a same number of SRS resources, and each of the SRS resources in the first SRS resource group corresponds to a respective one of the SRS resources in the second SRS resource group, and
two corresponding SRS resources satisfy one or more of: occupying a same physical resource; using a same transmission beam; or using a same transmission power.

9. The terminal device of claim 7, wherein the TPMI information indicates a precoding matrix for three antenna ports, and the three antenna ports are composed of the two antenna ports corresponding to the first SRS resource and the single antenna port corresponding to the second SRS resource.

10. The terminal device of claim 7, wherein
the TPMI information comprises a first TPMI and a second TPMI, the first TPMI is used for determining the precoding scheme on the antenna ports corresponding to the first SRS resource, and the second TPMI is used for determining the precoding scheme on the antenna port corresponding to the second SRS resource,
each of the first TPMI and the second TPMI indicates a number of transmission layers on the antenna ports corresponding to the first SRS resource and the second SRS resource respectively, and
a total number of transmission layers for uplink data is equal to a sum of the number of transmission layers indicated by the first TPMI and the number of transmission layers indicated by the second TPMI.

11. The terminal device of claim 7, wherein the processor is further configured to control the terminal device to:
transmit first information and second information to the network device,
wherein the first information indicates whether the two antenna ports corresponding to the first SRS resource are capable of supporting full power transmission, and the second information indicates whether the single antenna port corresponding to the second SRS resource is capable of supporting full power transmission.

12. The terminal device of claim 7, wherein the processor is further configured to control the terminal device to:
perform precoding on uplink data based on the precoding scheme; and
transmit the precoded data on the antenna ports corresponding to the first SRS resource and the second SRS resource,
wherein respective transmission layers in the uplink data are mapped to different antenna ports among the antenna ports corresponding to the first SRS resource and the second SRS resource, and
the respective transmission layers in the uplink data are mapped to the antenna port corresponding to the first SRS resource first, and then mapped to the antenna port corresponding to the second SRS resource, or the respective transmission layers in the uplink data are mapped to the antenna port corresponding to the second SRS resource first, and then mapped to the antenna port corresponding to the first SRS resource.

13. A network device, comprising:
a processor; and
a memory for storing a program executable by the processor;
wherein the processor is configured to execute the program to control the network device to:
transmit configuration information to a terminal device, wherein the configuration information is used for configuring a first sounding reference signal (SRS) resource group and a second SRS resource group, the first SRS resource group comprises one or more SRS resources for two antenna ports, and the second SRS resource group comprises one or more SRS resources for a single antenna port;
receive SRSs transmitted by the terminal device on the first SRS resource group and the second SRS resource group; and
transmit indication information to the terminal device, wherein the indication information comprises transmit precoding matrix indicator (TPMI) information, the TPMI information is used for determining a precoding scheme on antenna ports corresponding to a first SRS resource and a second SRS resource, the first SRS resource group comprises the first SRS resource, and the second SRS resource group comprises the second SRS resource.

14. The network device of claim 13, wherein
the first SRS resource group and the second SRS resource group are two SRS resource groups in a same SRS resource set, or the first SRS resource group and the second SRS resource group are two different SRS resource sets, and/or
one or more of following configurations for an SRS resource in the first SRS resource group and for an SRS resource in the second SRS resource group are the same: a frequency domain resource, a slot configuration, an orthogonal frequency division multiplexing (OFDM) symbol configuration, a frequency domain hopping configuration, a sequence hopping configuration, a cyclic shift hopping configuration, a comb offset hopping configuration, or a power control parameter.

15. The network device of claim 13, wherein
each SRS resource in the first SRS resource group corresponds to at least one SRS resource in the second SRS resource group,
the first SRS resource group and the second SRS resource group comprise a same number of SRS resources, and each of the SRS resources in the first SRS resource group corresponds to a respective one of the SRS resources in the second SRS resource group, and
two corresponding SRS resources satisfy one or more of: occupying a same physical resource; using a same transmission beam; or using a same transmission power.

16. The network device of claim 13, wherein the TPMI information indicates a precoding matrix for three antenna ports, and the three antenna ports are composed of the two antenna ports corresponding to the first SRS resource and the single antenna port corresponding to the second SRS resource.

17. The network device of claim 13, wherein
the TPMI information comprises a first TPMI and a second TPMI, the first TPMI is used for determining the precoding scheme on the antenna ports corresponding to the first SRS resource, and the second TPMI is used for determining the precoding scheme on the antenna port corresponding to the second SRS resource,
the first TPMI indicates whether the antenna ports corresponding to the first SRS resource are used for data transmission, and/or the first TPMI indicates a precoding matrix for the two antenna ports,
the second TPMI indicates whether the antenna port corresponding to the second SRS resource is used for data transmission,
the first TPMI comprises 2-bit information, and two bits in the 2-bit information indicate whether the two antenna ports corresponding to the first SRS resource are used for data transmission, respectively, or the 2-bit information indicates one of:
the precoding matrix is
$$\frac{1}{\sqrt{3}} [ \begin{matrix}1 \\ 0\end{matrix} ] ;$$
the precoding matrix is
$$\frac{1}{\sqrt{3}} [ \begin{matrix}0 \\ 1\end{matrix} ] ;$$
the precoding matrix is
$$\frac{1}{\sqrt{3}} [ \begin{matrix}1 & 0 \\ 0 & 1\end{matrix} ] ;$$
or
the two antenna ports are not used for data transmission.

18. The network device of claim 17, wherein
each of the first TPMI and the second TPMI further indicates a number of transmission layers on the antenna ports corresponding to the first SRS resource and the second SRS resource respectively, and
a total number of transmission layers for uplink data is equal to a sum of the number of transmission layers indicated by the first TPMI and the number of transmission layers indicated by the second TPMI.

19. The network device of claim 17, wherein
the first TPMI and the second TPMI are not allowed to both indicate that the corresponding antenna ports are not used for data transmission, or a number of transmission layers indicated by the first TPMI and a number of transmission layers indicated by the second TPMI are not allowed to both be 0, and/or
the processor is further configured to control the network device to: receive first information and second information from the terminal device, wherein the first information indicates whether the two antenna ports corresponding to the first SRS resource are capable of supporting full power transmission, and the second information indicates whether the single antenna port corresponding to the second SRS resource is capable of supporting full power transmission.

20. The network device of claim 13, wherein the processor is further configured to control the network device to:
transmit sounding reference signal resource indicator (SRI) information to the terminal device, wherein
the SRI information is used for determining the first SRS resource and the second SRS resource from the first SRS resource group and the second SRS resource group, respectively,
when the SRI information indicates an index n−1, the first SRS resource corresponds to an n-th SRS resource in the first SRS resource group, and the second SRS resource corresponds to an n-th SRS resource in the second SRS resource group,
the SRI information comprises a first SRI for determining the first SRS resource from the first SRS resource group and a second SRI for determining the second SRS resource from the second SRS resource group.
